(19) United States
(12) Patent Application Publication
(10) Pub. No.: US 2024/0104816 A1
(43) Pub. Date: Mar. 28, 2024

(54) MACHINE FEELING, AUTOMATED EMOTIONS, IMPULSIVE BEHAVIOR, AND GAMIFICATION OF DRAMA SYSTEM, METHOD & COMPUTER PROGRAM PRODUCT

(71) Applicant: Christopher Deane Shaw, Oakland, CA (US)

(72) Inventor: Christopher Deane Shaw, Oakland, CA (US)

(21) Appl. No.: 17/951,098

(22) Filed: Sep. 23, 2022

(51) Int. Cl. G06T 13/40

(52) U.S. Cl. CPC G06T 13/40

(57) ABSTRACT

A system, method and/or computer program product may include, a computer-implemented method of altering animated behavior of a character avatar or artificial character including: electronically establishing, by an electronic computer processor, at least one electronic data indicative of at least one parametric mathematical model configured to alter at least one kinetic property of the animated behavior of the character avatar or artificial character, in a manner that creates apparent changes of one or more of: mood, or personality, in the character avatar or artificial character being animated; electronically inserting, an animation representative of the at least one electronic data indicative of the at least one parametric mathematical model, wherein the animation representative of the at least one electronic data indicative of the at least one parametric mathematical model is inserted between timing: of displaying of animated behaviors of the character avatar or artificial character controlling the character avatar or artificial character, and of displaying of animated behaviors of the character avatar or artificial character being controlled, wherein the parametric mathematical model adds apparent mood and/or personality to the animations of the character avatar or artificial character; electronically storing, a set of at least one electronic data parameters applicable to the parametric mathematical model for a particular character avatar or artificial character, wherein at least one animation of the particular character avatar or artificial character may include displaying behavioral attributes portraying at least one personality, or mood of the particular avatar or artificial character; and electronically altering, the set of the at least one electronic data parameters relating to displaying varying emotional states in the character avatar or artificial character.

### BACKGROUND OF THE DISCLOSURE

### Field of the Disclosure

The application relates generally to virtual characters and more particularly to improvements to virtual characters.

### Related Art

Avatar Navigation:

In today's computer games, a human player may assert control over a virtual character that represents that player within the game's Virtual World. Such a virtual character is called an Avatar. The human player's controls over their Avatar currently tend to focus on activities such as; a) walking, running, or flying from place to place; b) pointing and shooting (to fire a weapon or select an object); c) physical combat, and d) manipulating Virtual Objects. Since all such controls involve spatially orienting the Avatar, we loosely classify them together as Avatar Navigation. In the course of a game, a player's Avatar may encounter other Avatars, which may be controlled by other players, or be independently automated as part of the game. Automated Avatars are also called Non-Player Characters (NPCs).

Avatar Interactivity—Procedural Chronology vs. Brachiated Chronology:

Brachiated Chronology shall refer to a method that achieves interactivity by first; 1) creating a variety of plot segments (branches) ahead of time, and then; 2) creating a mechanism whereby users (consciously or unconsciously) select a path through these pre-arranged branches to; 3) assemble a completed plot. This earliest form of interactivity has been widely used to piece together stories in ‘choose your plot’ books and video presentations as well as interactive games. In the earliest video games, Brachiated Chronology was also used to make an Avatar throw a pre-recorded punch when triggered by the player, or fall in a pre-recorded manner when hit by another Avatar.

Procedural Chronology shall refer to methods that achieve interactivity by mathematically computing reactions within the Virtual World in real time or near real time, so as not to be visibly discerned to a viewer. Procedural methods free interactivity from the confines of pre-determined outcomes.

For example, Procedural Chronology allows users to navigate their Avatar exactly as they like, rather than having to choose from pre-determined paths. Procedural Chronology also allows physical responses in the Virtual World, like the Avatar's falling down, or other response to impact, to be calculated from body Physics precisely matching the situation, rather than be patched in from a limited assortment of pre-determined body animations (as is the case with Brachiated Chronology). The Procedural method's more realistic responsiveness and freedom of movement makes users feel like they are really THERE in the Virtual World.

The economic success of games has spurred software and hardware advances in the rendering capabilities of consumer devices, so that Virtual Worlds and Characters in games now look increasingly real. This combination of realistic appearance with realistic responsiveness further multiplies the gaming medium's increasing popularity.

Gamification:

After exciting users with free and spontaneous Avatar Navigation, typical games impose challenges to that free navigation to keep things interesting. Such challenges may include virtual combatants (in the form of competing player's Avatars, or Non-Player Characters (NPCs)), as well as geographic boundaries, and various forms of puzzles. Games may also hold interest by scoring and/or rewarding players for overcoming the above challenges, as well as enabling players to compare their scores with other players, and compete in a public ranking. This overall process is called Gamification.

The success of Gamification is fueling expansion of 3D gaming medium into wider markets. Non-entertainment use of the 3D Gamified worlds, sometimes called Serious Games, has extended the medium's markets to include sales, therapy, education, and a myriad of other broader social uses. This rapid expansion of 3D gaming into wider use culminates in the concept of a Metaverse. These sudden new uses present a design challenge for a medium whose interactive appeal is firmly based on freedom of Navigation.

When the Avatar warrior becomes a teacher, salesperson, or therapist, Communication replaces Navigation as its primary function. Refocusing the core functionality of an evolved interactive archetype from Navigation to Communication presents a non-trivial design challenge.

Virtual World/Metaverse:

The hype surrounding this concept is such that a blinding array of technologies get called ‘Metaverse’ to generate publicity, funding or both. We will refer to the Metaverse as simply the Avatar(s) and the space in which they are perceived to exist. We apply this term, Metaverse, independently of the device used to display it, which means that ‘immersive’ displays such as Oculus, or Google Glass are included as well as Laptops, Smartphones and any other computer device which may be used to present an Avatar's voice or image.

Avatar Communication—Conventional References

The transition of Avatars from warriors to advocates, educators, and dramatists is already well underway. This section will deal with current technological methods used to enable Avatar Communication. Particular attention is given to the ongoing evolution of these methods, and existing future expectations, in order to distinguish novelty and nonobviousness of the disclosure's methods introduced as compared to conventional methods.

Robotry vs. Puppetry

There are 2 basic ways to make an Avatar appear to communicate: using it as a Puppet (wherein it mimics the emotions and/or voice of a human), or as a Robot (wherein its voice and behavior are generated independently). In current practice, these two methods are often mixed.

For clarity, we will begin by considering them separately.

Each method has distinct advantages and disadvantages. We begin with Puppetry.

Conventional References—Puppetry

Avatar Puppetry—Intro:

Advantages: The rich, dynamic emotivity of a natural human voice—especially when delivered by a talented actor—can add massive appeal to computer-generated characters. When the talented actor's expressions, gestures, and body movements are duplicated by the character as well, this appeal may expand even further.

Disadvantages: Puppetry techniques require a human controller. If no human controller is present during player interactivity, the technique relies on the Brachiated Chronology mode of recording various options ahead of time, and reducing interactivity to a selection from among these predetermined options. Spontaneity may be lost.

Solutions to these interactive disadvantages include Realtime Puppetry (described later in this section) and this disclosure's methods described in the following sections.

Avatar Puppetry—Conventional References—Techniques:

Syncing Avatars to Humans—Motion Capture (MOCAP) is a method which may be used to record data indicating an actor's lip position, facial expressions, gestures and larger body movements while recording the sound of their voice. This data can then generate matching movements in an Avatar while the actor's voice is being played, to make the Avatar appear to be speaking the human voice's sound.

MOCAP methods include placing positional or rotational sensors on an actor's body, as well as by computationally analyzing video, LiDAR, ToF or other wave-based data reflected from the actor and thereby extracting positional information about the actor. Advances in MOCAP are increasing its precision in capturing details of an actor, which now may include minute facial expressions, gaze direction, subtle shifts in body position, as well as movements of hair, clothing, or objects the actor manipulates. As Avatars become more and more realistic in appearance, this performance accuracy becomes increasingly vital, because of the Uncanny Valley effect.

The Uncanny Valley:

The Uncanny Valley effect is a psychological phenomenon that can make photoreal characters disturbing to people. We are instinctively tuned to suspect the motives of people who act strangely. When cartoon characters act oddly, it's expected. When characters that look just like us act oddly, our instinctive suspicion kicks in. This instinctive suspicion doomed early attempts to make movies with real-looking characters. (e.g. Northern Express), because the expressions and movements of the realistic characters were just a bit off. “Creepy” was a common audience reaction. Welcome to the Valley.

Overcoming the Valley in Movies:

In 2008, ICT created the first critically successful performance of a photorealistic artificial character in a movie in “The Curious Case Of Benjamin Button.” Improved MOCAP enabled them to create character movements and expressions that were so real, people couldn't tell the character was artificial. Improved MOCAP has been used successfully in movies many times since. Such movies may take hours to render each frame.

Overcoming the Valley in Realtime:

By 2016, rendering and MOCAP capabilities had advanced so far that a pleasing, photorealistic Avatar performance required under 1/30th of a second to render each frame. Nokia graphics proudly demonstrated this new capability by having an actress, wearing head-mounted cameras and full-body motion capture equipment, perform right alongside the character she was controlling. Welcome to Realtime.

Overcoming the Valley in Realtime at Home:

See, e.g., a TechCrunch article reproduced below, and accessible at URL: https://techcrunch.com/2017/04/11/unreals-photorealistic-character-sample-is-like-a-rob-lowe-from-the-uncanny-valley/This article entitled, “Unreal's ‘photorealistic character sample’ is like a Rob Lowe from the uncanny valley,” by Devin Coldewey@techcrunch, 6:32 PM EDT on Apr. 11, 2017, notes, “Making the character models you see in games is a very involved process, and as a few recent titles have shown, the faces especially are hard as hell to do right. The folks behind Epic's Unreal Engine, which powers more than a few of those games, have kindly offered a ‘photorealistic character sample’ a Rob Lowe-looking dude who looks almost real enough to touch. Almost. Here he is deep in thought so deep, in fact, he isn't breathing:” and links to: https://youtu.be/K-VyoqRB5_g and continues, “That's because animation is another discipline for another time. And anyway, Rob here isn't meant to be some kind of benchmark in realism. No, plenty of movies and games have models and lighting just as good as this, and better. But this face comes with all its bits and pieces explained by the wizards who made it, so you can try your hand at modifying it or building your own. ‘The purpose of sharing this content is to empower anyone to learn from, explore and deconstruct Epic's professionally created materials and models,’ reads the blog post announcing the model's availability. It's interesting even as a layperson to see the amount of care that goes into every little piece of this model, from realistically shading hair to self-occlusion on the eyeball. Try scrolling through the documentation here, but don't expect instructions on anything but realistically creating this particular white guy. Oh, and beware of nightmare fuel like this:” and links to: https://techcrunch.com/wp-content/uploads/2017/04/skindiffuse.jpg and ends with, “Gross, right?”

The photo-real characters now seen in high-end games are moving onto phones. Image recognition software is eliminating the need for body sensors. We're closing in on mass market Perfect Puppetry. Soon you may speak to others as an Avatar that is indistinguishable from a real person. And you may not know if the ‘person’ you're talking to is real or not. Impressive. Scary. Fascinating. Coming soon. But not enough.

The Metaverse Promises More.

Chatting through Avatar Puppets has limited advantages (at best) over Video Chat, which can already show real images of multiple speakers in separate windows. Video Chat is a much simpler, more direct way to enrich conversations with gestures and expressions.

Gesturing and talking through a fantasy Avatar may be entertaining for a moment, but the Metaverse promises far more than masquerade chat.

The Metaverse promises a revolutionary new form of communication that can give distant people the feeling of being together in the same space, with all of the empowerment, comfort, and efficiency togetherness brings. Recreating that sense of ‘being there’ with all its enhanced interactivity will require control methods that enable Avatars to ‘feel,’ and be affected by their Virtual surroundings. Separate control methods that restrict and reshape Avatar Puppetry's animations.

Avatar Robotry supplies such methods. And much more.

A deeper promise of the Metaverse is that it will evolve beyond literature and beyond movies into a fully formed new medium for creating psychological, metaphysical, and dramatic connections between the user and other people, both fictional and real. This will require a Perfect Robotry to match the Perfect Puppetry. The creation of an autonomous Avatar that is spiritually indistinguishable from a real human We will be exploring these concepts along with methods to approach their realization in the following sections.

Conventional References—Avatar Robotry.

Avatar Robotry—Intro:

Avatar Robotry refers to methods which enable an Avatar to act without human control. Such an Avatar uses an Artificial Voice and its animation generated by computer. Like Avatar Puppetry, Avatar Robotry has advantages and disadvantages.

Advantages: A huge advantage of an Artificial Voice is that it quickly adapts to search engines, A.I., chatbots, and a vast array of other software that generates text responses to user questions. Artificial Voice's Text to Speech (TTS) functionality, combined with Speech Recognition (SR), underlies Siri, Alexa, and countless other voice-activated, speaking virtual assistants.

Disadvantages: The problem with artificial voices is they tend to sound . . . umm . . . artificial. This problem is shrinking fast. TTS voices sound increasingly human. However, they still lack the emotional complexity, and range of a real voice, which makes them quickly feel redundant and detached with extended messaging. And then there's the Avatar's body and face. Robotic Avatar behavior tends to look . . . ummm robotic. As with the voice, quality is improving. This section will describe Avatar Robotry improvements already accomplished.

Avatar Robotry—Conventional References:

The Voice:

The convenience and ease of interfacing with computers by speaking and listening has inspired extensive development and broad use of voice-activated virtual assistants. Within their originally defined functionality, there is no reason for a virtual assistant to have any physical manifestation beyond its voice. More recently though, Avatars have been added to create a deeper psychological connection with users, for purposes such as therapy. entertainment, or education, which profit from an increase in user attention and time of involvement.

Adding a Body:

The addition of an Avatar to an Artificial Voice is well enough established that many cloud-based TTS engines are enabled to stream time-labeled phoneme data concurrently with the voice sound they generate. This time-labeled phoneme data may then be used to trigger lip positions in an Avatar while the sound of the voice is being played, to make it appear that the Avatar is speaking.

A problem with the above TTS solution is that, outside of the lips, it provides the Avatar with no animation. To keep the Avatar from looking like a stiff statue with moving lips, additional Robotry must bring it to life.

The Eyes.

The initial purpose of the Communication Avatar is to focus and engage users as it delivers its messages. In natural human behavior, a primary way to initiate conversation and maintain attention is to make eye contact. Basic programming is frequently used to duplicate this behavior by automatically rotating the Avatar's eyes to aim at the virtual camera (at you, the user). Once you've done that, it's fairly simple to program the Avatar's head, then shoulders to repeat the eyes' rotation with a little delay. Tuning that correctly (eyes turn, then head turns, then shoulders) it's not too hard to get a fairly accurate duplication of a person's response to seeing something a bit off to the side. Once this is completed, the Speaking Avatar becomes a stiff statue with moving lips that automatically looks directly at you.

Stick that animation on a photo-realistic character, and the Uncanny Valley effect will send people screaming from the room.

Luckily, solutions to this problem already exist in Conventional references . . . sort of.

Creating Robotic Avatars Frankenstein-Style, by Assembling Behavioral Components.

A fundamental methodology used to enrich Robotic Avatar animation was disclosed in

U.S. Pat. Nos. 6,147,692 and 6,320,583, the contents of all of which are incorporated herein by reference in their entirety, which include common inventorship, were filed in part by Christopher Shaw, one of the current disclosure's inventors. These incorporated patents introduced the method of adding together separate behavioral components to animate a speaking Avatar. One example includes; 1) starting with a neutral “base” character, and; 2) adding an emotive mouth morph (smile, frown, pout, etc.), then 3) adding a viseme morph (lip position for speech phoneme), and then 4) repeating this process over time to make an Avatar apparently emote while speaking. This disclosure's method of combining behavioral components is used today in most speaking, emoting 3D characters in computer games and movies.

When used in movies, the method functions as Puppetry, syncing the character to a natural voice, and adding behavioral components derived from human animators or MOCAP.

When used interactively, this method helps Robotic Avatars escape the Uncanny Valley. Today's visualized virtual assistants commonly add life to their Avatars by programming multiple behavioral components to run concurrently with the Avatar's TTS animation. Robotic animation methods for these components include programming different randomness generators, or asynchronous cycles. Such techniques combine to reduce repetitiveness in the facial expressions of the Avatar, making it appear less Robotic. Subtle rotations of joints in the body can be programmed in a similar asynchronous manner to create non-repeating shifts in posture.

Such effects, called ‘dithering,’ have some success in making Robotic Speaking Avatars behave in a more natural manner when at rest, or delivering a message using TTS.

The problem with dithering is that it is merely biological background noise. It may make a Robotic Avatar's behavior convincing at first, but as the Avatar speaks, it will increasingly seem dull and pointless if its expressions and gestures are unconnected to its words.

The connection between Robot and message can be enhanced by methods that use words, phrases or meanings programmatically extracted from the text of the TTS voice to trigger the application of facial expressions and body movements during speech. Existing software libraries that extract the emotive content of written text may be useful in such methods.

Adding Diversity and Mobility to Speaking Avatars.

The methodologies discussed so far are limited in scope. They enable a speaking avatar to change expression and gesture, but beyond that, the avatar is frozen in place, a sitting or standing announcer. This lack of behavioral diversity limits a speaking avatar's ability to grab and hold attention over time.

Conventional references methods which address this problem by combining Puppetry with Robotry are discussed in the following section, Puppetry/Robotry Blends. Let's stick with pure Robotry for now.

Pure Robotry Applied to Avatar Bodies—Conventional References

A Physics Engine is the name commonly given to the set of physics-based equations used to control the motions of objects within a computer game. The realtime calculations of Physics Engines that bring spontaneous realism to falling buildings and swirling smoke, have been applied to give this same Procedural realism to falling Avatars and swirling Avatar hair.

Ragdoll Physics is the informal name given to the physics equations which animate the movements of falling or tumbling Avatar by constructing a physics-based model of that Avatar's body, and then calculating effects, including collisions with the virtual environment and gravity, as the Avatar falls. The realtime calculations of Ragdoll Physics make Avatars tumble in more diverse and responsive ways than stored animations are able to. Yet another example of the real cause and effect of Procedural Chronology making the Virtual World more real.

Procedural Chronology can create active as well as passive Avatar body animations.

Purely Robotic software enabling Avatars to walk has been around for a long time. In 2000, U.S. Pat. Nos. 6,057,859, 6,088,042, 6,191,798, the contents of all of which are incorporated herein by reference in their entirety, introduced impressive methods, which animated “fully interactive goal-directed behaviors, such as bipedal walking, through simultaneous satisfaction of position, alignment, posture, balance, obstacle avoidance, and joint limitation constraints.”

The ability of such active and passive Robotry methods to instantly calculate precise physical Avatar responses gives players a more realistic, spontaneous, touchable feeling of BEING THERE to physical interactions with Avatars.

When the focus of Avatar interactivity shifts from Navigation to Communication, the focus of the Robotry shifts from generating physical responses to generating emotional responses.

Behavior that can simulate understanding, encouragement, anger, friendship, mood and personality. Robotry that simulates the human spirit.

Mathematically generating such behavior will require a Psychology Engine that calculates Avatar Emotions the same way a Physics Engine calculates an Avatar Motions.

Such a Psychology Engine is proposed in “Spontaneous animation methods [to]generate apparent emotions and apparent willful actions in artificial characters”, U.S. Pat. No. 10,207,405, the contents of all of which is incorporated herein by reference in its entirety, invented by Christopher Shaw, one of the current disclosure's inventors.

Simplifying to the most basic terms, the difference between this prior patent by the same inventor and the current disclosure is as follows:

This prior patent may enable the synthesis of human emotional reactions in an artificial character as it interacts with a human user. The goal is to duplicate an emotional connection between a user and an artificial character.

Conventional References—Avatar Robotry—Overview

The creation of the Perfect Robot (generating human behavior) is nowhere near that of the Perfect Puppet (imitating human behavior).

In the absence of Perfect Robot Avatars, real solutions happening right now include Puppetry/Robotry Blends.

### SUMMARY OF THE INVENTION

According to an exemplary embodiment of the invention, a system, method and/or computer program product may be provided setting forth various exemplary features.

According to an exemplary embodiment of the invention, a system, method and/or computer program product may be provided including a computer-implemented method of altering animated behavior of a character avatar or artificial character which may include: electronically establishing, by at least one electronic computer processor, at least one electronic data indicative of at least one parametric mathematical model configured to alter at least one kinetic property of the animated behavior of the character avatar or artificial character, in a manner that creates apparent changes of at least one or more of: mood, or personality, in the character avatar or artificial character being animated; electronically inserting, by the at least one electronic computer processor, an animation representative of the at least one electronic data indicative of the at least one parametric mathematical model, wherein the animation representative of the at least one electronic data indicative of the at least one parametric mathematical model is inserted between timing: of displaying of animated behaviors of the character avatar or artificial character controlling the character avatar or artificial character, and of displaying of animated behaviors of the character avatar or artificial character being controlled, wherein the Parametric Mathematical model adds apparent mood and/or personality to the animations of the character avatar or artificial character; electronically storing, by the at least one electronic computer processor, a set of at least one electronic data parameters applicable to the parametric mathematical model for a particular character avatar or artificial character, such that at least one animation of the particular character avatar or artificial character may include displaying behavioral attributes portraying at least one personality, or mood of the particular avatar or artificial character; and electronically altering, by the at least one electronic computer processor, the set of the at least one electronic data parameters relating to displaying varying emotional states in the character avatar or artificial character.

According to one example embodiment, the method may include where the character avatar or artificial character is controllable by human users, and/or the character avatars or artificial character are animated autonomously.

According to one example embodiment, the method may further include e) mathematically linking, by the at least one electronic computer processor, the emotive parameters of various avatars to link the behavior of these avatars in a manner that portrays an emotional dynamic between them.

According to one example embodiment, the method may include where the character avatars comprise at least one or more of: wherein the character avatar or artificial character is controllable by at least one human user via at least one electronic user controller device, or wherein the character avatar or artificial character is animated autonomously.

According to another example embodiment, the method may include a method of altering a behavior of at least one avatar in at least one virtual environment, wherein each of the at least one avatar is controlled by at least one user device controller of at least one human user, may include: electronically establishing, by at least one electronic computer processor, a psychological animation system of generating apparent personality or mood characteristics in an animation of the at least one avatar; electronically enabling, by the at least one electronic computer processor, the psychological animation system to at least one or more of electronically interrupt or electronically alter control of the animation coming from the at least one user device controller of the at least one human user of the at least one avatar in a manner may include portraying in the at least one avatar, at least one or more of an apparent mood, a personality, or another psychological factor, as revealed in the animation.

According to one example embodiment, the method may further include electronically providing, by the at least one electronic computer processor, a method of altering the psychological animation system to display varying emotional states in the at least one avatar.

According to one example embodiment, the method may further include electronically enabling, by the at least one electronic computer processor, electronically triggering of impulsive behaviors by the at least one avatar, wherein the psychological animation system may include assuming increased control over the at least one user device controller, and an animation input for the at least one avatar to display at least one impulsive behavior in a final animation.

According to one example embodiment, the method may include where the at least one impulsive behavior partially or completely replacing a human user's input from the at least one user device controller.

According to one example embodiment, the method may further include electronically enabling, by the at least one electronic computer processor, the user-control restrictions imposed by these Impulsive Behaviors as challenges impeding the human controller's ability to guide their avatar toward a specified goal in a game-type situation.

According to one example embodiment, the method may further include electronically enabling, by the at least one electronic computer processor, the triggering of non-user spoken dialogue in the avatar, wherein non-user dialogue is stored or AI-generated, and is spoken by the at least one avatar, rather than dialogue input of the human controller.

According to one example embodiment, the method may include where the non-user dialogue may include at least one or more of: is electronically added to, electronically partially replaces, or electronically completely replaces, the electronically input of the human controller.

According to yet another example embodiment, the method may include a method of procedurally generating emersive emotive behavior in avatars or robots, may include: electronically establishing, by at least one electronic computer processor, electronic data indicative of a set of parametric mathematical models capable of electronically simulating kinetic properties of human physiological responses and actions in a manner that may be parametrically tuned to electronically simulate various physiological or psychological states; electronically combining, by the at least one electronic computer processor, the separate parametric mathematical models in a coupled dynamical system which may represent an electronic linking of these various physiological factors into combined parameters; and electronically enabling, by the at least one electronic computer processor, the coupled dynamical system to procedurally animate unscripted catastrophic emersive behaviors under fluctuations in the combined parameters.

According to one example embodiment, the method may include where the electronic data indicative of physiological responses and actions mathematically electronically modeled comprise at least one or more of: large muscle movement, fine muscle movement, or fluctuations in vocal dynamics during speech.

According to one example embodiment, the method may include where the fluctuations comprise extreme fluctuations as measured by a pre-determined threshold of variability of fluctuation in the combined parameters.

Automated Personality and Mood—

This disclosure may enable Automated Emotions (AE)—a set of parameters assigned to an Avatar—to cause that Avatar to exhibit an apparent personality, which may persist regardless of who or what is controlling it. These AE methods may act in tandem with an Avatar's AI software, to add emotion to the verbal responses generated by the Artificial Intelligence. This approximate “heart and mind” split of functionality may persist through methods presented herein.

Human-Controlled vs. Autonomous Avatars—

When the Avatar is autonomous (a non-player character (NPC)), some form of AI may take the role of the Avatar's “mind” while this disclosure's AE controls the Avatar's “heart.” When an Avatar may be controlled by a person, that person may become the Avatar's “mind,” while the AE controls the Avatar's “heart” as before.

Impulsive Behaviors—

This disclosure's methods enable the Avatar's AE “heart” to—upon occasion—overwhelm controls arriving from the entity functioning as its “mind.” These occasions shall be referred to as Impulsive Behaviors.

Machine Feeling—

This disclosure may enable Procedural animation to auto-generate original Impulsive Behaviors in an unsupervised manner. This may be referred to as unsupervised Machine Feeling, in parallel to unsupervised Machine Learning. Because Machine Feeling is physiologically derived, it has inherent preferences, and may be of use in solving AI-hard situations in which an AI system may lack the necessary knowledge prerequisite to respond. (example code to be submitted as appendix with Patent)

Gamification of Drama—

This disclosure teaches methods which enable the Gamification of Drama by challenging users to overcome their Avatar's Impulsive Behaviors to attain a willful goal. In calm situations, Impulsive Behaviors may subtly affect the Avatar's animation, so that it performs the user's commands in a manner consistent with the Avatar's designated mood at that moment. In more extreme cases, Impulsive Behaviors may dramatically emerge, overwhelming the user's attempts to control the Avatar. Such episodes may be used to depict psychological events such as the Avatar “losing its temper,” or “succumbing to addiction,” during which episodes the human controller acts as the Freudian Ego struggling to control the powerful forces of the Id. This disclosure's procedural integration of drama and personality into Avatar interactivity may extend the breadth of appeal and functionality of Avatars for uses including gaming, education, therapy, and beyond.

This Disclosure—Preview:

This disclosure's methods extend the Procedural spontaneity and freedom now found in Virtual Navigation, into Virtual Communication as well.

Procedural Navigation frees users from restricted choices when walking, running, flying, driving, pointing, selecting, shooting, fighting. This disclosure's Procedural Communication methods free Avatars' reactions (which may include mood, personality, gestures, tone of voice, and emotional responses) from the restrictions of pre-defined choices. These Procedural Avatar reactions may, in turn, enable Procedural Chronology to determine the course of evolving virtual relationships.

In this manner, the REALLY THERE appeal of free movement within the virtual world can be extended to a REALLY THERE appeal in emotional relationships with characters and plots.

The current disclosure may enable modulation of emotional reactions in artificial characters. The goal is to duplicate evolving relationships, to embed players in these relationships, and to thereby Gamify Drama.

This disclosure addresses that gulf.

Why do people want a Perfect Robot?

To soothe a timeless, human desire for life beyond mortal flesh, which may. drive Art, Religion, and Culture in general.

Perfect Puppetry gives us imaginary escape from the flesh by projecting us into a digital double. Perfect Robotry gives real immortality to our digital double . . . . Back to Earth.

Robotry/Puppetry Blends—Intro:

Until now, this description has separated Robotry and Puppetry techniques. In practice, Robotry and Puppetry techniques are commonly mixed together in software that aims to synthesize natural human behavior.

Methods that blend Robotry and Puppetry tend to follow an evolutionary pattern: earliest efforts are highly reliant on Puppetry (more natural); later efforts drift toward Robotry (more spontaneous) as the Robotry gets better at imitating Nature; ultimate solutions strive to eliminate human sourcing altogether—approaching the Perfect Robot.

An example of this evolution is seen in today's Artificial Voices, which generate their realism by starting with a real person's voice (Puppetry), and then stitching together pieces of that recorded voice to make complete sentences (Robotry).

Early Artificial Voices combine large chunks of voice recordings, such as phrases or entire sentences. Puppetry prevails, and the Brachiated Chronology voice can only say certain things.

Current Artificial Voices, called concatenated, combine tiny, phoneme-sized snippets of recorded voice to make full words, Robotry is more prevalent, the process more resembles Procedural Chronology, and the voice can say virtually any written text. Concatenated voices sound like the person providing source files, with some adjustment possible. (e.g. speech synthesis markup language (SSML))

Emerging Artificial Voices generate very human-sounding speech without any human voice source at all. Machine Learning makes these newest, purely artificial voices indistinguishable from real people. They can vocalize any written text. Parametric adjustments change mood, inflection, accent, gender, age and many other properties.

Adding Puppetry to Robotic Avatars

The extracted Artificial Voice text used to trigger expressions in virtual assistants, can also be used to trigger short animated sequences—like hand gestures—which are recalled from memory. Extending this use of animation to include longer MOCAP sequences will make our virtual assistant more diverse and interesting. Longer Puppetry segments can enable the virtual assistant to go get things, to give demonstrations, to dance for joy, etcetera. Increased reliance on these stored, pre-determined behaviors strips away some of the freedom and spontaneity of realtime calculations. The curse of Puppetry.

As already mentioned, this curse becomes a blessing when Puppetry is realtime, and the human controller is part of the show. Blending realtime Puppetry with more sophisticated Robotry opens up a whole new world of application for Avatar Robotry. This new role for Robotry is the core of methods that the current disclosure will be teaching.

Current Disclosure Preview—In this new role, Robotry becomes an intermediary between a user and their Avatar. In this empowered role, the Procedural Robot intercepts the Puppetry data as it travels from a human user to their Avatar, and this Robot may completely change the user's words, facial expressions, gestures, body movements and all other elements of the Avatar's performance. All in realtime.

The purpose of these new methods is to Gamify dramatic plots, in which the goal is building relationships, gaining empathy, avoiding psychological melt-downs. Games where success depends on skill in Communication.

Communication-Based Interactivity Structures

The Gamification of Drama

There has long been a desire to add the emotional impact of movies to the navigational challenges of computer games. The earliest of these efforts involved the literal insertion of movies into games.

Game/Movie Hybrids:

Early methods to inject the emotional impact of ‘movie-like’ drama into games involved producing actual movie segments related to the game. Such segments might show the game Avatar's history, or otherwise set up the plot. These segments were then inserted into the game. The quality of the Avatar's look and emotive performance in these hand-produced, slowly rendered mini-movies could far exceed that of the Avatar in the actual game. In spite of this difference, inserting such video segments has been effective in inspiring players to emotionally invest in the outcome of the games they are playing.

Games now can feature Avatars that are photoreal and worlds that are difficult to distinguish from movies. Producers no longer need to insert video to create these quality inserts. Instead, they can capture the performance of an actor wearing MOCAP, and use the data and sound from that quality performance to animate the Avatar in their game engine.

In both of the above cases, the effectiveness of a patchwork presentation of polished, dramatic inserts is limited by the fact that these inserts are not integrated into the actual gameplay.

This is the Earliest step in the evolution of Interactive Drama from Brachiated Chronology to

Procedural Chronology. Next step . . . .

Story-Driven Games

A more integrated approach to bringing the emotionality of movies to games is seen in the genre of “story-driven” games. These games begin by embedding the user's Avatar in a dramatic situation. Actual gameplay involves controlling the Avatar's choices as it makes its way through the challenges and twists of an unfolding plot. An example story-driven videogame is “Resident Evil,” which has beautiful graphics, and fairly convincing performances by realistic characters that loom out of the darkness to issue dire warnings and deliver tips. The problem is that such characters' performances are not interactive, so they vanish right after issuing their warnings. The game player is left to make Avatar decisions by clicking buttons that offer options like “walk”, “run”, or “view map”; rather than by speaking with the tipster, like a real person would do in a haunted house with zombies after them.

This reliance on buttons reveals a problem deeper than the artificial tipster's inability to converse, which could be reasonably addressed with speech recognition and imagination.

The deeper problem the buttons reveal is that story-driven games rely on limited choices.

Conversations chosen from rigidly scripted branches on a ‘dialogue tree’.

Plots chosen from predetermined outcomes. Bracheated Chronology.

Imagine if Avatar Navigation meant picking from 3 or 4 paths, instead of freely exploring an expansive Virtual World.

That's the state of games involving Avatar Communication today. See, e.g., URL: https://www.twitch.tv/myre—users speak in games Star Citizen

Procedural Chronology in Relationships and Stories

PATENT PREVIEW—The methods introduced in the current disclosure will apply Procedural Chronology to Interactive Drama. These same methods apply to Sales, Therapy, Education, and other “Serious Games.”

The Goal: extend the REALLY THERE appeal of free virtual navigation to a REALLY THERE appeal in emotional relationships with characters and plots.

### BRIEF DESCRIPTION OF DRAWING FIGURES DEPICTING SEVERAL ILLUSTRATIVE VIEWS OF THE EXAMPLE EMBODIMENTS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. The drawing in which an element first appears is indicated by the leftmost digits in the corresponding reference number. A preferred example embodiment is discussed below in the detailed description of the following drawings:

FIG. 1 shows an example embodiment of an illustration depicting an example block diagram of an example method of animating an interactive Virtual Assistant Avatar;

FIG. 2 shows an example illustration depicting an example block diagram of this disclosure's method of animating an interactive Virtual Assistant Avatar;

FIG. 3 shows in greater detail an example illustration depicting an example block diagram of the AE from FIG. 2, according to one example embodiment;

FIG. 4 shows an illustration depicting an example block diagram of an example embodiment of a functional restructuring of the AE software detail shown in FIG. 3;

FIG. 5 shows an illustration of an example embodiment of the current disclosure's methods applied to an Avatar representing the user in a Metaverse, VR, AR, or any other Virtual World, according to one example embodiment;

FIG. 6 shows an illustration of a blending of Robotry, MOCAP, and Stored Animation in the current disclosure's method of animating an Avatar, according to one example embodiment, for use in representing the user in a Virtual World;

FIG. 7: depicts an example embodiment of an illustration of a Natural Voice Option, according to one example embodiment. All other illustrative figures have been shown using an artificial voice, according to one example embodiment;

FIG. 8: depicts an example illustration of example Parametric Coupling, according to one example embodiment.—Synthesizing Emotional Relationships Two or more users, each controlling their own AE enabled Avatar, in one embodiment;

FIG. 9: depicts an example illustration 900 of an example Physical Coupling. Navigation, Collision, according to one example embodiment;

FIG. 10: depicts an example illustration 1000 of a Close Up of Parameters To Behavior (PTB) Method, from FIG. 6, according to one example embodiment;

FIG. 11: depicts an example illustration 1100 of a close Up of PTB—Emergent Behavior Example from FIGS. 6 and 10, according to one example embodiment; and

FIG. 12 depicting an example block diagram of an example user computing system as may be used as a hardware system architecture for one or more electronic computer devices including a client device, an electronic communications network device or a server device according to an example embodiment.

### DETAILED DESCRIPTION OF VARIOUS EXAMPLE EMBODIMENTS

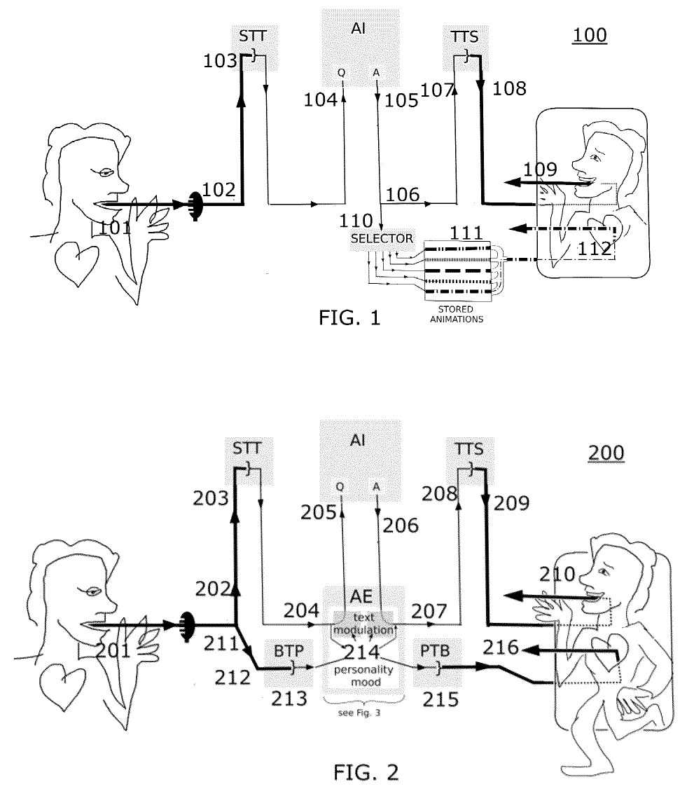

FIG. 1 shows an example embodiment of an illustration depicting an example block diagram 100 of an example method of animating an interactive Virtual Assistant Avatar.

According to one example embodiment, in 101: the user may speak to a client device, which may include or be a smartphone, tablet, laptop, or other computer device, according to one example embodiment.

According to one example embodiment, in 102: the device may include a microphone may record that user's voice, in one embodiment.

According to one example embodiment, in 103: Speech To Text (STT) software, which may be located at least partially in the cloud, may create a written version of the user's statement. Note: STT may also be called Speech Rec or speech recognition (SR), in one example embodiment.

According to one example embodiment, in 104: this text version of the user's words (much lower bandwidth than the user's voice soundfile) may then be passed to some form of Artificial Intelligence (AI), in one embodiment. This AI may be a narrow chatbot that only answers frequently asked questions (FAQs) for a company, a wide application that may access general Internet search functionalities (such as, e.g., but not limited to, Siri, or Alexa, Google, Bixby, etc.), some combination of these offerings, or any other software that generates text responses to text input, in one example embodiment.

According to one example embodiment, in 105: a text response may be formulated by this AI, in one embodiment.

According to one example embodiment, in 106: this response may be passed in two directions (107, 110), in one embodiment.

According to one example embodiment, in 107: this text response may be sent to a Text to Speech (TTS) engine, which may be a cloud-based external software, in one embodiment.

According to one example embodiment, in 108: this TTS software may convert this text response to an artificial voice soundfile, along with a text-based file that lists phonemes and timing during the voice soundfile, in one embodiment.

According to one example embodiment, in 109: the user's client device may play the soundfile on the device's line out while simultaneously using the phoneme text file to animate the Avatar's lips, in one embodiment.

According to one example embodiment, in 110: the A.I. response may be also sent in some form to a Selector, which chooses to play from Stored Animations, in one embodiment.

According to one example embodiment, in 111: stored Animations may be fixed, predetermined data sequences which may make an Avatar gesture or change expression, in one embodiment.

According to one example embodiment, in 112: the chosen animation(s) may play on the Avatar on the client's device concurrently with the lip animations deriving from TTS, in one embodiment.

VIRTUAL ASSISTANT—DISCLOSURE (PRESENTED FOR CONTRAST), in one embodiment.

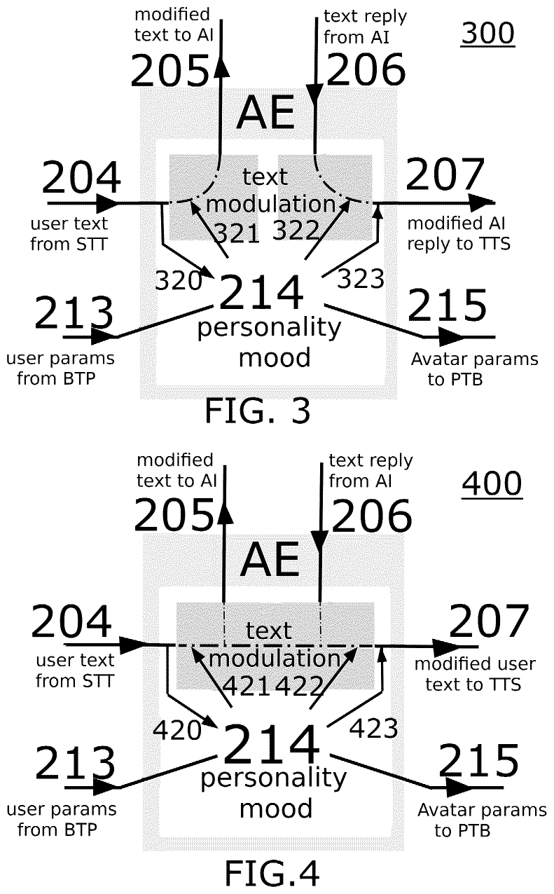

To distinguish this disclosure's method from conventional methods we start with a diagram of a conventional Virtual Assistant's method. (see FIG. 1), according to one example embodiment. In this example, a user's comments to the Virtual Assistant may be recorded by a mic on their device and sent to a Speech to Text (STT) engine (also known as Speech Rec.) which converts the sound of the user's voice to text (see FIG. 1, 103), according to one example embodiment. This text (far lower bandwidth than sound) may be then conveyed to some form of AI (see FIG. 1, 104), according to one example embodiment. AI in this context may refer to any functionality capable of returning a text response to text input: from a narrow chatbot, to an NLP-enabled bot with deep contextual understanding, and beyond, according to one example embodiment. Said AI creates a text response (FIG. 3, 105) which may be then delivered to a Text to Speech (TTS) engine (FIG. 1, 107), which then may convert that text to an Artificial Voice sound file, plus a text-based list of phonemes and timing thereof (FIG. 1, 108), according to one example embodiment. These files may be sent to the Avatar display device which plays the sound while moving the Avatar's lips with the phoneme file (FIG. 1, 109), according to one example embodiment.

So much for Avatar speech, on to animation: gestures, blinks, smiles, etcetera. Such animated features may be stored in memory, and triggered either by timers set on intervals, or cues within the AI-generated text (FIG. 1, 110 & 111), according to one example embodiment.

Virtual Assistant—this Disclosure's Method.

This disclosure's method of creating a Virtual Assistant differs from the conventional ways and Applicant's methods may be illustrated in FIG. 2, according to one example embodiment.

FIG. 2 shows an example illustration depicting an example block diagram 200 of this disclosure's method of animating an interactive Virtual Assistant Avatar.

According to one example embodiment, in 201: the user may speak to their client device, which may be a smartphone, tablet, laptop, or other computer device, according to one example embodiment.

According to one example embodiment, in 202: the device's microphone may record that user's voice, and that recorded sound may be sent in two directions (203, 211), in one embodiment.

According to one example embodiment, in 203: Speech To Text (STT) software, which may be located at least partially in the cloud, creates a written version of the user's statement, in one embodiment.

According to one example embodiment, in 204: this text version of the user's words (much lower bandwidth than the user's voice soundfile) may be then passed to this disclosure's Automated Emotion (AE) software, which may then modify this text version of the user's words in accordance with factors including its parametrically defined mood or personality at that time, in one embodiment.

According to one example embodiment, in 205: this modified text version of the user's words may then be passed to some form of Artificial Intelligence (AI) capable of formulating text responses to text input. This AI may be a narrow chatbot that only answers FAQs for a company, a wide application that may access general Internet search functionalities (such as Siri or Alexa), some combination of the two, or any other software that may generate text responses to text input, in one embodiment.

According to one example embodiment, in 206: a text response may be generated by this AI, in one embodiment.

According to one example embodiment, in 207: this AI text response may be sent back to this disclosure's AE software, which may modulate the text content, and may also embed settings for the artificial voice's pitch, speed, and other characteristics, in one embodiment.

According to one example embodiment, in 208: this modulated text response may be sent to a Text to Speech (TTS) engine, which may be a cloud-based external software, in one embodiment.

According to one example embodiment, in 209: the TTS software may convert this text response to an artificial voice soundfile (in accordance with any voice quality instructions if included). The TTS software may also generate a text-based file that may list the phonemes pronounced and the time they occur during the voice soundfile, in one embodiment.

According to one example embodiment, in 210: the user's client device may play the voice soundfile to the device's line out while simultaneously using the phoneme text file to animate the Avatar's lips, in one embodiment.

According to one example embodiment, in 211: the user's voice sound may be also streamed to Behavior to Parameter (BTP) software. According to one example embodiment, in 212: This Behavior to Parameter (BTP) software may extract behavioral parameters, such as nervousness, from the jitteriness of the user's behavior as extracted from their video or voice recording, in one embodiment.

According to one example embodiment, in 213: these extracted parameters (much lower bandwidth than source sound) may be sent to Automated Emotion (AE) step, in one embodiment.

According to one example embodiment, in 214: in the Automated Emotion (AE) step, these parameters may be extracted from the user may mathematically influence parameters which may set Avatar's personality, current mood, and other features (see detail FIG. 3), in one embodiment.

According to one example embodiment, in 215: these AE parameters may be sent to the Parameter To Behavior (PTB) step, which may generate and may modify Avatar animations so that they may reflect the AE's intended emotional stat, in one embodiment e.

According to one example embodiment, in 216: the AE's ‘emotivated’ animations, played on the client, may include full body movements suitable for Avatar use in larger environments such as VR, AR, and gaming, in one embodiment.

As before, the user's comments to the Virtual Assistant may be recorded by a mic on their device and sent to a Speech to Text (TTS) engine which converts the sound of the user's voice to text (see FIG. 2, 203), according to one example embodiment.

Here's where the difference begins, according to one example embodiment. This text may be then conveyed to the AE (rather than going directly to the AI) (see FIG. 2, 204), according to one example embodiment. This insertion of AE in the command chain may enable “emotionally motivated” Compulsive Behaviors on the part of the Avatar to influence or overwhelm the AI controls, as will be described in detail later, according to one example embodiment. The verbal content of the AI response to the user may be altered before this response may be sent (still in text-format) to the TTS (FIG. 2, 208) where that text may be turned into the Artificial Voice the Avatar will use to reply, according to one example embodiment. The AE may send instructions altering the tone of that Artificial Voice reply as well, according to one example embodiment.

So much for the content and tone of the Avatar's spoken reply, according to one example embodiment. On to the Avatar's body language, according to one example embodiment.

An Avatar's AE may ‘perceive’ users' emotions by analyzing input data from the user (FIG. 2, 2012), according to one example embodiment. In this particular case, kinetic elements of the user's speech—such as word rate, pitch variability, volume variability—may be used to indicate emotional state, according to one example embodiment. This inventor's prior patent Ser. No. 10/207,405, the contents of which is incorporated herein by reference in its entirety, describes how other data such as facial expression and user movements determined from video, or speed and rate of finger or mouse movements may be used to determine emotive parameters in users, according to one example embodiment. The extraction of emotive parameters may be performed in the Behavior to Parameter (BTP) step, according to one example embodiment.

Data extracted from users may be passed to the Avatar's Automated Emotions to mathematically influence another set of parameters which may determine the Avatar's apparent personality and mood, according to one example embodiment. These parameters may be then used in the Parameter to Behavior (PTB) step to insert emotion into an Avatar's animated behavior, according to one example embodiment. The mathematics of how such parameters may insert apparent personality and mood into animation may be described in “Spontaneous animation methods [to] generate apparent emotions and apparent willful actions in artificial characters,” U.S. Pat. No. 10,207,405, the contents of which is incorporated herein by reference in its entirety.

Impulsive Behaviors—

A unique feature of this disclosure's method may be that it may enable Impulsive Behaviors, according to one example embodiment. Impulsive Behaviors shall refer to AE control methods (the Avatar's “heart”) which may be enabled to override human and/or AI controls (the Avatar's “mind”), according to one example embodiment.

Impulsive Behaviors may be used to simulate the Avatar “losing its temper” or being “overcome with fear,” according to one example embodiment.

The enablement of such Impulsive Behaviors may require, according to one example embodiment, two example functionalities: 1) a means of triggering these Impulsive Behaviors, and 2) a means of generating the animation the Impulsive Behavior uses to replace the animation generated by the AI “mind” in normal circumstances, according to one example embodiment. This disclosure will propose a number of methods to trigger and generate Impulsive Behavior, according to one example embodiment.

To show Impulsive Behavior methods in greater detail, FIG. 3 presents a closeup of the Virtual Assistant AE shown in FIG. 2, according to one example embodiment.

FIG. 3 shows in greater detail an example illustration depicting an example block diagram 300 of the AE from FIG. 2, according to one example embodiment.

According to one example embodiment, in 204: as in previous FIG. 2, Speech Recognition software (STT) passes a text version of the user's words to this disclosure's Automated Emotion (AE) software, in one embodiment.

According to one example embodiment, in 320: text from the incoming user's stream may be imported to the AE to be analyzed for emotive content, in one embodiment.

According to one example embodiment, in 321: the Avatar's emotional state, defined by the AE, may alter the content of incoming text from the user, prior to sending it to the AI for a response, in one embodiment.

According to one example embodiment, in 205: as in previous FIG. 2, this modified text may be sent to the AI, in one embodiment.

According to one example embodiment, in 206: as in previous FIG. 2, The text reply may be received by the AE from the AI, in one embodiment.

According to one example embodiment, in 322: the AE may also alter the text content of replies from the AI to the user, in accordance with the Avatar's AE emotional state, in one embodiment.

According to one example embodiment, in 323: the AE may alter the quality of the Avatar's voice (as well as the content), in one embodiment.

According to one example embodiment, in 207: as in previous FIG. 2, this modulated text response and voice tuning data may be sent to a Text to Speech (TTS) engine, which may be a cloud-based external software, in one embodiment.

According to one example embodiment, in 213: as in previous FIG. 2, emotive parameters extracted from user behavior may be sent to the AE software, in one embodiment.

According to one example embodiment, in 214: as in previous FIG. 2, the AE may start with a designated set of base parameters (which may be considered a ‘personality’) and then mathematically alter them in response to incoming parameters derived from the user (or another Avatar), in one embodiment.

According to one example embodiment, in 215: as in previous FIG. 2, these adapted parameters may be sent to Parameter to Behavior (PTB) software which may set these parameters in functions which modify incoming Avatar animations involving dialogue or movements, regardless of source, to reflect the AE's emotional state in the Avatar's overall performance, in one embodiment.

The text of the user's words may be analyzed for emotive parameters, (FIG. 3, 220), according to one example embodiment. This extraction of emotive parameters may be accomplished using available lists giving such information about common words, according to one example embodiment.

These parameters which have been derived from the user may mathematically influence parameters of the Avatar's Automated Emotional state, according to one example embodiment. For example a user-derived parameter indicating ‘energy’ or ‘happiness’ may simply be reflected by the Avatar's matching AE parameter (more sophisticated couplings will be discussed later), according to one example embodiment.

The Avatar's Automated Emotional state may change the content of the message sent to the AI (FIG. 3, 221), according to one example embodiment. For example, if a parameter controlling ‘anger’ exceeds a certain level, the Avatar may be too “pissed off” to respond, and simply delete the user's question, according to one example embodiment. Or, if an Avatar's “suspicion” parameter exceeds a certain level, the AE program may insert critical remarks into the outgoing text stream to ‘trick’ the AI into giving defensive responses for the Avatar to deliver, according to one example embodiment (NOTE: the use of emotive parameters, including “suspicion” and “anger,” to generate effective animations is described in this disclosure's inventor's previous Patents, U.S. Pat. Nos. 6,147,692 and 6,320,583, the entire contents of which are incorporated herein by reference in their entirety.)

An avatar may alter incoming AI responses as well (FIG. 3, 222), according to one example embodiment. For example, a sufficiently “pissed off” Avatar may be programmed to insert insults into the responses the AI scripts for it, according to one example embodiment. The AE's parameters may also alter the emotional tone of the Artificial Voice created by the TTS (FIG. 3, 23), according to one example embodiment.

The above covers how Automated Emotion triggers and animates Impulsive Behavior related to Speech, according to one example embodiment. But speech may be only one way humans convey emotion, according to one example embodiment.

The non-verbal expressions of Impulsive Behavior may communicate in a raw, instinctive fashion, according to one example embodiment. The kinetics of movement, such as the speed and jitter of voice tone fluctuations, body position changes, and facial movements, may clearly indicate—even to an animal—a recognizable form of Impulsive Behavior, according to one example embodiment.

“Spontaneous animation methods [to] generate apparent emotions and apparent willful actions in artificial characters”, U.S. Pat. No. 10,207,405, the entire contents of which are incorporated herein by reference in their entirety, describes methods that can parametrically tune the kinetics of animations to portray various emotional states, according to one example embodiment. The current disclosure's addition of Impulsive Behavior requires a step in addition to tuning animations, according to one example embodiment. Impulsive Behaviors must also animate their own behaviors to stand in for the behaviors they may be replacing, according to one example embodiment.

FIG. 4 shows an illustration depicting an example block diagram 400 of an example embodiment of a functional restructuring of the AE software detail shown in FIG. 3. According to one example embodiment, in 204: as in previous FIG. 2, Speech Recognition software (STT) may pass a text version of the user's words to this disclosure's Automated Emotion (AE) software, according to one example embodiment.

According to one example embodiment, in 207: the content of the user's text may be passed directly to the TTS so that the Avatar parrots the user's phrase, unless that text may be modified by one of the following steps.

According to one example embodiment, in 420: text from the incoming user's stream may be imported to the AE to be analyzed for emotive content. The content of the user's words may remain unchanged in this step.

According to one example embodiment, in 421: the Avatar's emotional state, may be defined by the AE, may alter the content of the user's original dictation to their Avatar, in one embodiment.

According to one example embodiment, in 205: the AE may also—in certain conditions—divert text to the AI, in one embodiment.

According to one example embodiment, in 206: as in previous FIG. 2, AI's response to text may be returned to the AE, in one embodiment.

According to one example embodiment, in 422: the AE may also alter the content of the AI's text response, in accordance with the Avatar's AE emotional state, in one embodiment.

According to one example embodiment, in 423: the AE may alter the quality of the Avatar's voice (as well as the content), in one embodiment.

According to one example embodiment, in 213: as in previous FIG. 2, emotive parameters may be extracted from user behavior may be sent to the AE software, in one embodiment.

According to one example embodiment, in 214: as in previous FIG. 2, the AE may start with a designated set of base parameters (which may be considered a ‘personality’) and then may mathematically alter them in response to incoming parameters derived from other sources (which may be considered a “mood”), in one embodiment.

According to one example embodiment, in 215: as in previous FIG. 2, these adapted parameters may be sent to Parameter to Behavior (PTB) software, which may use them to add personality and mood to Avatar animations, in one embodiment.

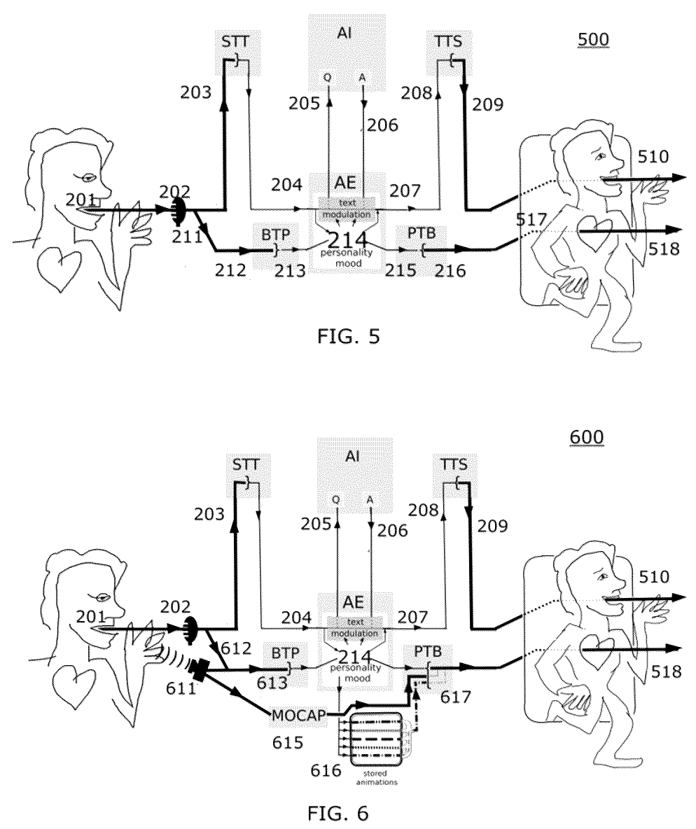

FIG. 5 shows an illustration 500 of an example embodiment of the current disclosure's methods applied to an Avatar representing the user in a Metaverse, VR, AR, or any other Virtual World, according to one example embodiment.

According to one example embodiment, in 201: The user may speak to their client device, which may be a smartphone, tablet, laptop, VR headset, or other computer device, in one embodiment.

According to one example embodiment, in 202: The device's microphone may record that user's voice, and that recorded sound may be sent in two directions (3, 11), in one embodiment.

According to one example embodiment, in 203: Speech To Text (STT) software, which may be located at least partially in the cloud, may create a written version of the user's statement, in one embodiment.

According to one example embodiment, in 204: This text version of the user's words may be then passed to Automated Emotion (AE) software, which may simply pass on the user's text (to 7) so that their Avatar parrots the user's words; or the AE may modify the user's words in accordance with factors including the Avatar's AE personality or mood at that time, in one embodiment.

According to one example embodiment, in 205: A version of the user's words may be passed to some form of Artificial Intelligence (AI) capable of formulating text responses to text input, in one embodiment.

According to one example embodiment, in 206: A text response may be generated by this AI and sent back to the AE, in one embodiment.

According to one example embodiment, in 207: The AE software, which may modulate the text content, and may also embed settings for the artificial voice's pitch, speed, and other characteristics, in one embodiment.

According to one example embodiment, in 208: This modulated text response may be sent to a Text to Speech (TTS) engine, which may be a cloud-based external software, in one embodiment.

According to one example embodiment, in 209: The TTS software may convert this text response to an artificial voice soundfile (in accordance with any voice quality instructions if included). The TTS software may also generate a text-based file that may list the phonemes pronounced and the time they occur during the voice soundfile, in one embodiment.

According to one example embodiment, in 510: The user's client device may play the voice soundfile to the device's line out while it may simultaneously use the phoneme text file to animate the Avatar's lips, in one embodiment.

According to one example embodiment, in 211: The user's voice sound may be also streamed to Behavior to Parameter (BTP) software, in one embodiment.

According to one example embodiment, in 212: This Behavior to Parameter (BTP) software may extract behavioral parameters, such as nervousness, from the jitteriness of the user's behavior as extracted from their video or voice recording, in one embodiment.

According to one example embodiment, in 213: These extracted parameters (much lower bandwidth than source sound) may be sent to Automated Emotion (AE) software, in one embodiment.

According to one example embodiment, in 214: The Automated Emotion software may use the prior step's parameters in modulating Avatar behavior to, e.g. but not limited to, match the user, or to alter the Avatar's behavior in accordance with the Avatar's e.g., but not limited to, personality, current mood, and other features, etc., in one embodiment.

According to one example embodiment, in 215: These consolidated, modified parameters may be sent to Parameter To Behavior (PTB) software which may generate and modify Avatar animations to reflect the AE's assigned emotional state.

According to one example embodiment, in 216: The PTB uses the parameters to create spontaneous, ‘emotivated’ animations, which may include full body movements, in one embodiment.

According to one example embodiment, in 517: The prior step's ‘emotivated’ animations may be played on the client's device, in one embodiment.

According to one example embodiment, in 518: Such full-body, ‘emotivated’, animations enable Avatar use in larger environments such as VR, AR, and gaming, in one embodiment.

FIG. 6 shows an illustration 600 of a blending of Robotry, MOCAP, and Stored Animation in the current disclosure's method of animating an Avatar, according to one example embodiment, for use in representing the user in a Virtual World.

According to one example embodiment, in 201: the user speaks to their client device, which may be a smartphone, tablet, laptop, VR headset, or other computer device, according to one example embodiment.

According to one example embodiment, in 202: the device's microphone may record that user's voice, and that recorded sound may be sent in two directions (3, 12), in one embodiment.

According to one example embodiment, in 203: Speech To Text (STT) software, which may be located at least partially in the cloud, creates a written version of the user's statement, in one embodiment.

According to one example embodiment, in 204: this text version of the user's words may be then passed to Automated Emotion (AE) software, which may pass on the user's text (to 7) so that their Avatar parrots the user's words, in one embodiment; or the AE may modify the user's words in accordance with factors including the Avatar's AE personality or mood at that time, in one embodiment.

According to one example embodiment, in 205: a version of the user's words may be passed to some form of Artificial Intelligence (AI) capable of formulating text responses to text input, in one embodiment.

According to one example embodiment, in 206: a text response may be generated by this AI and sent back to the AE, in one embodiment.

According to one example embodiment, in 207: the AE software, which may modulate the text content, and may also embed settings for the artificial voice's pitch, speed, and other characteristics, in one embodiment.

According to one example embodiment, in 208: this modulated text response may be sent to a Text to Speech (TTS) engine, which may be a cloud-based external software, in one embodiment.

According to one example embodiment, in 209: the TTS software may convert this example text response to an artificial voice soundfile (in accordance with any voice quality instructions if included), in one embodiment. The TTS software may also generate a text-based file that lists the phonemes pronounced and the time they occur during the voice soundfile, in one embodiment.

According to one example embodiment, in 510: the user's client device may play the voice soundfile to the device's line out while it may simultaneously using the phoneme text file to animate the Avatar's lips, in one embodiment.

According to one example embodiment, in 611: Interface devices may record user data which can indicate the user's emotional state, in one embodiment. Such data may include video of the user, speed and steadiness of the user's finger or mouse input, and other such factors, in one embodiment.

According to one example embodiment, in 612: sound of the user's recorded voice can also indicate emotional state, and may be added to the above user data flow, in one embodiment.

According to one example embodiment, in 613: Behavior to Parameter (BTP) software may extract behavioral parameters, such as, e.g., but not limited to, nervousness, from the, e.g., jitteriness (jitterings, jitters, jitteriness, etc.), of the user's behavior as extracted from user data which may include video and/or voice recording, as well as other interface input, in one embodiment.

According to one example embodiment, in 214: the Automated Emotion software may use the prior step's parameters in modulating Avatar behavior to either match the user, or to alter the Avatar's behavior in accordance with the Avatar's personality, current mood, and other features, in one embodiment.

615: Captured user data may also be sent to MOCAP software to create Puppetry animations which match the user's moves, in one embodiment.

According to one example embodiment, in 616: Pre-recorded animations may also be stored and recalled, in accordance with Brachiated Chronology techniques, in one embodiment.

According to one example embodiment, in 617: in addition to generating and ‘emotivating’ Robotic animations, PTB software may modify MOCAP and Brachiated Chronology animations to reflect emotion, as described in U.S. patent Ser. No. 10/207,405, the contents of which is incorporated herein by reference in its entirety.

According to one example embodiment, in 518: these spontaneous, ‘emotivated’ animations, played on the client, may include full body movements suitable for Avatar use in larger environments such as VR, AR, and gaming, in one embodiment.

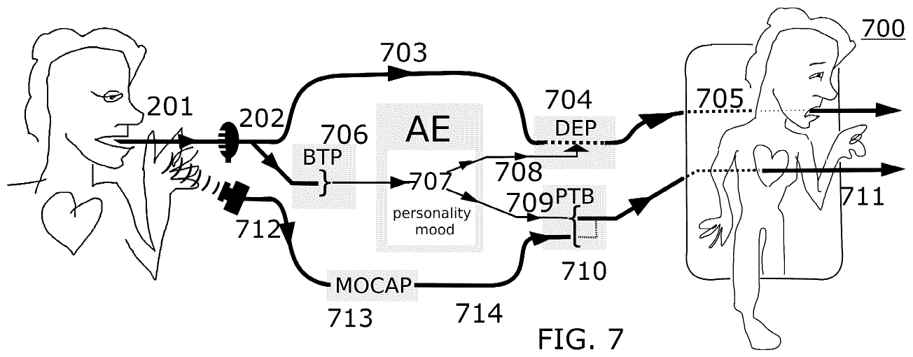

FIG. 7: depicts an example embodiment of an illustration 700 of a Natural Voice Option, according to one example embodiment. All other illustrative figures have been shown using an artificial voice, according to one example embodiment.

Natural Voice, according to one example embodiment, can be used with the methods presented in this disclosure, as shown here.

According to one example embodiment, in 201: the user speaks to their client device, which may be a smartphone, tablet, laptop, VR headset, or other computer device.

According to one example embodiment, in 202: the device's microphone may record that user's voice, and that recorded sound may be sent in two directions (3, 6), in one embodiment.

According to one example embodiment, in 703: the recorded voice may be sent to a Digital Effects Processor, in one embodiment.

According to one example embodiment, in 704: the Digital Effects Processor may transpose elements of that sound, such as pitch and rate, to affect the emotive impact of the voice, in one embodiment.

According to one example embodiment, in 705: this revised voice may be streamed to the Avatar's display mechanism, and may be played there to make the Avatar appear to be speaking with a modified voice, in one embodiment.

According to one example embodiment, in 706: the user's voice may also be streamed to the Behavior to Parameter (BTP) software, where data (including lip position during speech) may be extracted, in one embodiment.

According to one example embodiment, in 707: this data may be streamed to the Avatar's Automated Emotions (AE) where it may be modified and passed through according to the Avatar's mood and personality parameters at that moment, in one embodiment.

According to one example embodiment, in 708: these revised mood and personality parameters may be used to set the Digital Effects Processor so that it creates a desired emotive effect on the user's voice, in one embodiment.

According to one example embodiment, in 709: this data (including lip positions) may also be sent to the PTB, in one embodiment.

According to one example embodiment, in 710: the PTB may specify Robotic animations (including lip positions) as well as modify the emotional ‘mood’ or ‘vibe’ of all animations, in one embodiment.

According to one example embodiment, in 711: the Avatar may perform these ‘emotivated’ animations while the modified voice may be playing, in one embodiment.

According to one example embodiment, in 712: interface devices such as video may record the user, in one embodiment.

According to one example embodiment, in 713: MOCAP software (including face detection) may be used to determine the user's position, in one embodiment.

This method may be used as an alternative to extracting lip sync position from voice sound, in one embodiment.

According to one example embodiment, in 714: the MOCAP animation streams to the PTB (10), where it may be modified to exhibit the current Automated Emotional state of the Avatar, in one embodiment.

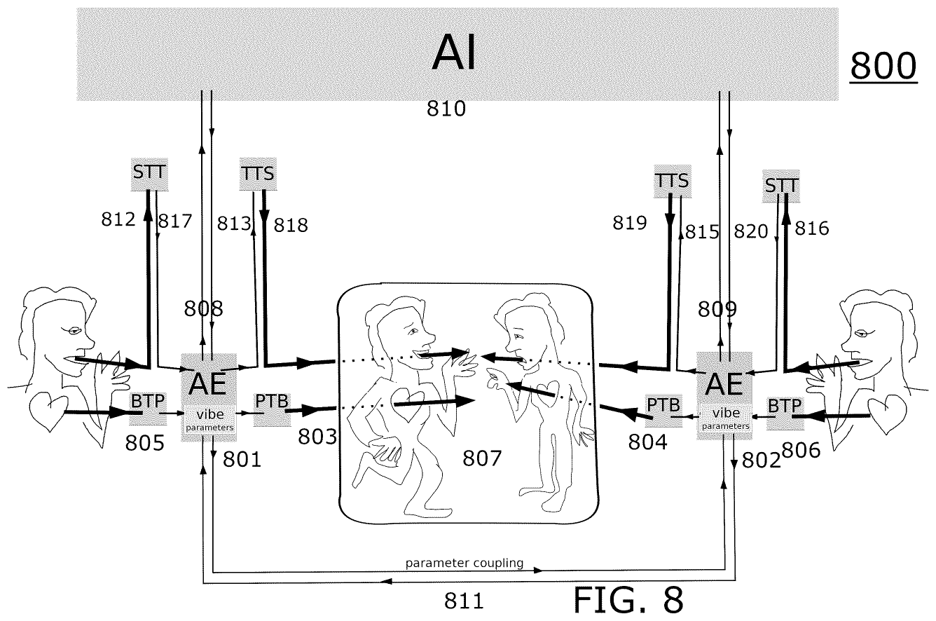

FIG. 8: depicts an example illustration 800 of example Parametric Coupling, according to one example embodiment.—Synthesizing Emotional Relationships Two or more users, each controlling their own AE enabled Avatar, in one embodiment.

According to one example embodiment, in 805 & 806: as earlier, each user's Avatar may be influenced by that user's emotive and verbal input.

According to one example embodiment, in 801 & 802: separate user Avatars may have separate Automated Emotional states, which may distort their user's input to varying degrees, in one embodiment.

According to one example embodiment, in 803 & 804: these separate AE's may set different Avatar moods in their different PTB's, in one embodiment.

According to one example embodiment, in 807: differing PTB settings may cause Avatars in a scene to act out different emotional states, even when given identical animation input from users, AI, or any other source, in one embodiment.

According to one example embodiment, in 808 & 809: AI may assert a degree of control over Avatar behavior, ranging from subtle nuance during normal user control, to completely replacing the user (during psychotic Avatar episodes, or when the Avatar in an NPC/Virtual Assistant role), in one embodiment.

According to one example embodiment, in 810: AI in this context may refer to anything from a narrow chatbot, to an NLP-enabled bot with deep contextual understanding, and beyond, in one embodiment.

According to one example embodiment, in 811: AE parameter-coupling may enable mirroring, counter-mirroring, and other sub-verbal behavioral linkages to act in consort with other functionalities such as AI, in one embodiment.

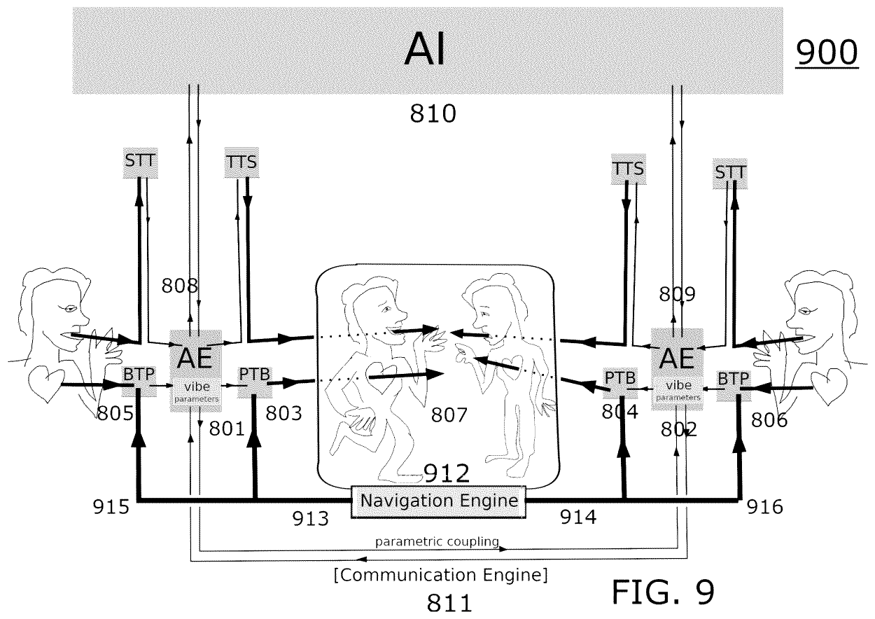

FIG. 9: depicts an example illustration 900 of an example Physical Coupling. Navigation, Collision, according to one example embodiment.

According to one example embodiment, in 912: a Physics Engine may be added to the prior FIG. 8 (Emotive Parameter Coupling), in one embodiment. In this document we use that term to include the part of a Game Engine that defines Avatar movement and body position within a typical Navigational game, in one embodiment.

According to one example embodiment, in 913 & 914: these Avatar animations may be exported to indicate the body positions and displacement of the Avatar during the progression of the game, in one embodiment.

According to one example embodiment, in 803 & 804: such animation may be diverted to the appropriate Avatar's PTB module where they may be ‘emotivated’ in accordance with the procedures in U.S. Pat. No. 10,207,405, the contents of which is incorporated herein by reference in its entirety.

According to one example embodiment, in 915 & 916: the game's Avatar animations may also be sent to the appropriate Avatar's Behavior to Parameter (BTP) module for extraction of emotive parameters from physical interactions which may affect mood, in one embodiment, (including walking, running, fighting, collision detection, and other such elements), in one embodiment.

(The following labels from preceding FIG. 8 may be included here for clarity, in one embodiment).

According to one example embodiment, in 805 & 806: as earlier, the user's emotive and verbal input may control their Avatar to a varying degree, depending on the current Automated Emotional state of that Avatar they may be controlling, in one embodiment.

According to one example embodiment, in 801 & 802: separate Avatars may have separate Automated Emotional states, in one embodiment.

According to one example embodiment, in 803 & 804: these separate Automated Emotions may set different moods in their different PTB's.

According to one example embodiment, in 807: separate Avatars in a scene may act out different emotional states, even when given identical animation input by their users, in one embodiment.

According to one example embodiment, in 808 & 809: AI may also assert a degree of control over Avatar behavior, which may range from subtle nuance during normal user control, to completely replacing the user during psychotic Avatar episodes, or when using the Avatar in a fully NPC/Virtual Assistant role, in one embodiment.

According to one example embodiment, in 810: AI in this context may refer to any functionality capable of returning a text response to text input, from a narrow chatbot, to an NLP-enabled bot with deep contextual understanding, and beyond, in one embodiment.

According to one example embodiment, in 811: AE parameter coupling may enable mirroring, counter-mirroring, and other sub-verbal behavioral linkages, in one embodiment.

Animated Impulsive Behavior

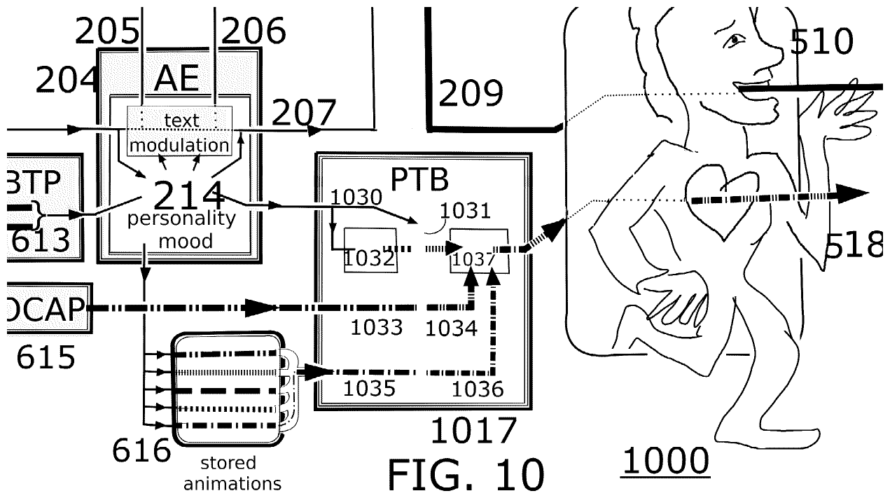

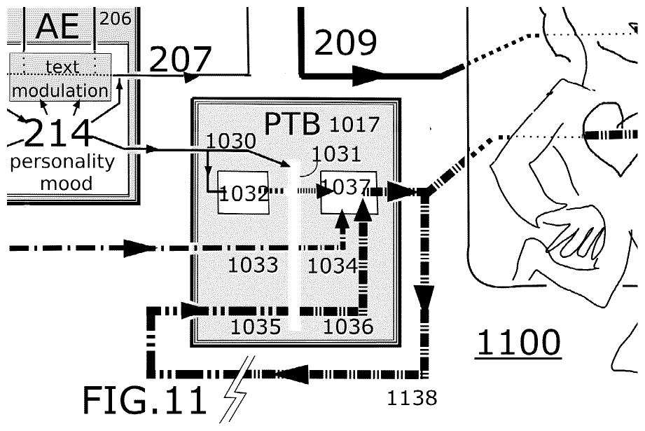

Spontaneous Animation's emotive tuning can be combined with various animation methods as shown in FIG. 10, according to one example embodiment.

FIG. 10: depicts an example illustration 1000 of a Close Up of Parameters To Behavior (PTB) Method, from FIG. 6, according to one example embodiment.

According to one example embodiment, parameters may be established within Automated Emotions, according to one example embodiment, in (FIG. 10, 214) control functions setting the personality and mood portrayed in the Avatar's animation, in one embodiment. These parameters pass to Parameter to Behavior (PTB) steps which may convert them to animations, according to one example embodiment, in (FIG. 10, 1030), in one embodiment. The parameters may be entered into Dynamic Functions, according to one example embodiment, in (FIG. 10, 1031) which may modify the kinetics of animations and voice characteristics so that they portray an apparent mood or personality in the Avatar, in one embodiment.

According to one example embodiment, these same Dynamic Equations may modify other sources, including the following, in one embodiment: Robotic Avatar animations, according to one example embodiment, in (FIG. 10, 1032), which may be triggered by the above Parameters, and; MOCAP animations deriving from the user (FIG. 10, 1033), in one embodiment, and;

Stored animation sequences, which may be triggered by the above Parameters (FIG. 10, 1035).

According to one example embodiment, once the may be modified by the Dynamic Equations, the modified MOCAP animations (FIG. 10, 1034), in one embodiment and/or modified stored animations (FIG. 10, 1036), and/or Robotic Animations may be combined (FIG. 10, 1037) and may create a final Avatar animation, in one embodiment.

Parameters derived to portray the AE's personality and mood, (FIG. 10, 214) may be entered into the spontaneous animation equations (FIG. 10, 1031) which can tune various animations to display apparent emotional states, according to one example embodiment. These parameters may also enable the triggering of Robotic animations (FIG. 10, 1031), according to one example embodiment. These Robotic animations may be as simple as the earlier described Dithering functionality, or more sophisticated Robotry, as described in this document's earlier reference to U.S. Pat. Nos. 6,057,859, 6,088,042, and 6,191,798, the entire contents of which are incorporated herein by reference in their entirety, according to one example embodiment. These Robotry animations may then be emotivated by the spontaneous animation methods to further reflect the Avatar's current state, according to one example embodiment. An additional source of Impulsive Behavior animations may be MOCAP animations derived from the user, according to one example embodiment, in (FIG. 10, 1033), which may then be emotionally reinterpreted by the spontaneous animation equations, according to one example embodiment, in (FIG. 10, 1034), before being incorporated into a mirroring component of the Impulsive Behavior animation, according to one example embodiment, in (FIG. 10, 1037), according to one example embodiment. Another source of Impulsive behavior animations, according to one example embodiment, may be stored animations, according to one example embodiment, in (FIG. 10, 1037), which may be triggered by the AE, according to one example embodiment, in (FIG. 10, 214) when certain emotive parameters exceed a critical value, according to one example embodiment, in (FIG. 10, 1035), according to one example embodiment. Once triggered, these stored animations may also be emotivated by the spontaneous animation equations, according to one example embodiment, in (FIG. 10, 1031), before being incorporated into the overall Avatar animation portraying the Impulsive Behavior, according to one example embodiment, in (FIG. 10, 1037), according to one example embodiment. The method of combining these various animation components into a final animation may include a mathematical weighting moderated by the AE parameters, as well as a combination of their effects in some form, and these combined effect may be limited by physical constraints imposed by the Avatar's body limitations, or by factors deriving from the Avatar's virtual environment, according to one example embodiment.

According to one example embodiment, these animation components may be typically selected or tuned (supervised) by a human designer to represent the Impulsive Behavior to which they may be assigned, according to one example embodiment.

Emergent Impulsive Behavior—Machine Feeling

According to one example embodiment, a more sublime method of generating Impulsive Behavior may be to enable unsupervised Emergent Behaviors to arise within dynamical systems of the Automated Emotion's PTB functionality, according to one example embodiment. Enabling unsupervised Emergent Behaviors in Automated Emotions parallels enabling unsupervised learning in Artificial Intelligence, according to one example embodiment.

Exemplary artificial intelligence systems may include any of various well known systems including, e.g., but not limited to, neural networks, expert systems, etc. can be refined via machine learning, such as, e.g., but not limited to, using predictive analytic techniques, artificial intelligence (AI) techniques, heuristics, machine learning (ML), neural networks and rules based expert systems, and the like, according to exemplary embodiments. an exemplary embodiment of an exemplary artificial intelligence (AI) platform, available from GOOGLE, a division of ALPHABET CORPORATION, of Palo Alto, CA USA, which is an exemplary, but nonlimiting machine learning (ML) platform enabling development of ML projects from ideation to production and deployment, enabling data engineering, flexibility, and an integrated tool chain for building and running ML predictive analytics applications, supporting a KUBEFLOW open-source platform, allows building portable ML pipelines, which can run on-premises or on cloud without significant code change, and including TENSORFLOW, TPUs, and TFX tools as enabling deployment of production AI applications, according to an exemplary embodiment; such as, e.g., an exemplary embodiment of an exemplary GOOGLE cloud AI technology stack as can be used to implement any of various exemplary embodiments.

FIG. 11: depicts an example illustration 1100 of a close Up of PTB—Emergent Behavior Example from FIGS. 6 and 10, according to one example embodiment.

According to one example embodiment, in Parameters established within Automated Emotions (FIG. 11, 214) control functions setting the personality and mood portrayed in the Avatar's animation, in one embodiment. These parameters may be passed to Parameter to Behavior (PTB) steps which convert them to animations, (FIG. 11, 1030), in one embodiment. Said parameters may be entered into Dynamic Functions (FIG. 11, 1031), in one embodiment, which may modify the kinetics of animations and voice characteristics so that they portray an apparent mood or personality in the Avatar, in one embodiment. According to one example embodiment, the same Dynamic Equations may modify other sources, in one embodiment, including the following: Robotic Avatar animations (FIG. 11, 1032), which may be triggered by the Parameters, in one embodiment, and; Kinetic data from the user (FIG. 11, 1033 & 1034), in one embodiment, and;

According to one example embodiment, the combined animation may be derived from the preceding loop's elements (FIG. 11, 1035 & 1036). These elements may be combined (FIG. 11, 1037) to create the current loop's animation including 1138 described further below, in one embodiment.

Appendix 1 of this disclosure provides an example code that creates a concrete example of such Emergent Impulsive Behavior, according to one example embodiment. A description of that code follows, according to one example embodiment.

Example Code—Emergent Impulsive Behavior (See Appendix 1)

According to one example embodiment, Emergent Impulsive Behavior may be generated by adding extra steps of 1) linking the output of the PTB (FIG. 11, 1138) to the input of that same PTB (FIG. 11, 1035) and 2) connecting the user input data directly to that same PTB (FIG. 11, 1033) so that behavior of the user may be dynamically coupled to behavior of the Avatar, according to one example embodiment. The width of the arrows may be intended to indicate the relative degree of control which each animation source may exert as the system enters Impulsive Behavior, according to one example embodiment. For example, in the emergent “swoon” described below, the user's excessive input drives the Avatar's AE Parameters past a critical value where the system shifts phase and damps out input until it can recover, according to one example embodiment. When the Avatar may be in this ‘damped’ state, even though the Avatar's repeating animation loop (FIG. 11: 1035, 1036, 1037, 1138) may be the least active animation in terms of displacement and speed, it filters out the control of the others, according to one example embodiment.

According to one example embodiment, initial conditions—the Avatar's body may be dynamically tuned to duplicate the kinetic factors of human emotional flow under standard circumstances, according to one example embodiment. For example, the mathematical models governing the Avatar's eye movements, body movements, and facial expression transitions, may be all tuned to respond in a manner that appears natural under normal-use changes in their AE parameters (e.g., the ‘suspicion’, ‘energy level’, or ‘happiness’ parameters mentioned earlier, etc.), according to one example embodiment. When PTB couplings may be reconfigured as described above, the user—by acting in an unusually hyper manner—may be enabled to push the Avatar's automated responses well beyond their normal range, according to one example embodiment. In such cases, the Avatar's behavior may radically shift in a manner which resembles a real human's response to extreme stress, according to one example embodiment. This radical shift in behavior may be not designed by intent, but may be an emergent systemic phase change in the physiologically based, non-linear dynamical system modelling normal emotions, enabled by the coupling of that system to the natural oscillations in user behavior, according to one example embodiment. The computer is enabled to design its own Impulsive Behavior, according to one example embodiment.

According to one example embodiment, describing this example's progression in non-technical terms, if the user sufficiently overstimulates this Avatar, its response switches from growing agitation to a highly believable swoon, which shuts down any response to the user's input until the Avatar recovers, according to one example embodiment. All of this happens in a manner which profoundly imitates natural behavior. Plus, it fills both the triggering and animation requirements of synthesized Impulsive Behavior. And it's all spontaneously created by the system itself, according to one example embodiment.

Moving from NPCs to User-Controlled Avatars

According to one example embodiment, so far we've been dealing with autonomous Avatars (NPCs), according to one example embodiment. According to one example embodiment, when AE may be applied to a user-controlled Avatar, Impulsive Behaviors may play an entirely new role, according to one example embodiment. According to one example embodiment, impulsive behaviors that interfere with your ability to control your Avatar “self,” may represent character flaws, addictive tendencies, or compulsions, which you must overcome to succeed in an interactive drama, according to one example embodiment.

According to one example embodiment, as we move from NPCs to user-controlled Avatars, the a substantial change may be that the user's voice, rather than the AI, must now supply the Avatar's words, according to one example embodiment. FIG. 4 according to one example embodiment, shows the changes in AE method from the earlier NPC version shown in FIG. 3, according to one example embodiment.

According to one example embodiment, as in the previously described NPC method, Speech Recognition software (STT) passes a text version of the user's words to the Avatar's Automated Emotions (AE) (FIG. 4, 4), according to one example embodiment.

According to one example embodiment, as with the NPC method, emotive parameters extracted from this user text may be used to tune the Avatar's Automated Emotions, according to one example embodiment. (FIG. 4, 20).

Here's where, according to one example embodiment, the difference between this and the NPC method may begin:

According to one example embodiment, because the Avatar may be now functioning as a spokesperson for the user (rather than for an AI), the text of the user's comment may be passed directly to the TTS (FIG. 4, 207), which then translates this unchanged text into an Artificial Voice which makes the Avatar exactly parrot the user's words, according to one example embodiment. This exact parroting will happen, according to one example embodiment, unless . . . .

According to one example embodiment, unless the user's text may be modified by one of the following steps:

According to one example embodiment, in (FIG. 4, 421): Impulsive Behaviors within Avatar's AE, may alter the content of the user's original dictation to their Avatar, according to one example embodiment. These impulsive changes in the original text may be triggered and activated as before (FIG. 3, 321), according to one example embodiment. The difference may be that Impulsive Behaviors depicting events such as a loss of temper, may be now applied directly on the user's control of their Avatar, according to one example embodiment. This may enable a dramatic device, wherein new media may now interactively simulate a narrative character's struggle to control one's temper, with a user's struggle to control their Avatar in a tempting, annoying Virtual World, according to one example embodiment.

According to one example embodiment, in (FIG. 4, 205) The AE may also, according to one example embodiment—in certain parametrically defined conditions—divert some portion of the user's text to the AI, according to one example embodiment. For dramatic use, this diversion to AI may be used to depict an Avatar ‘talking to itself’, ‘listening to its conscience’, or ‘suffering from schizophrenia’, according to one example embodiment. For more pragmatic uses, an Avatar might replace user statements such as, “I don't know”, with the correct Internet answer to whatever question triggered the user's statement, according to one example embodiment.

According to one example embodiment, in (FIG. 4, 206) The AI's response to the text sent, in the step above, may be returned to the AE, according to one example embodiment.

According to one example embodiment, in (FIG. 4, 422) The AE may also alter the content of the AI's text response, in accordance with the Avatar's AE emotional state, according to one example embodiment. Simple uses may include the insertion of terms of endearment or insults, as dictated by the Avatar's Automated Emotion parameters, according to one example embodiment.

According to one example embodiment, in (FIG. 4, 423) the AE may send commands to alter the tone of the Avatar's voice to match its mood, as determined by the AE emotional parameters, according to one example embodiment.

The preceding points enable Impulsive Behaviors in the user-controlled AE Avatar's speech, according to one example embodiment. The all important physical behavior of the user-controlled AE Avatar may be covered in the next section, according to one example embodiment.

Mixed Control Methods:

FIG. 6 shows according to one example embodiment, a blending of Robotry, MOCAP, and Stored Animation methods in a user-controlled AE Avatar, according to one example embodiment. According to one example embodiment, we described such mixed control scenarios above earlier, according to one example embodiment.

According to one example embodiment, this section intends to clarify their specific application to AE Avatars tuned for dramatic use, and their role in enabling Impulsive Behavior, according to one example embodiment.

According to one example embodiment, in (FIG. 6, 611) putting the user in the Avatar's role increases the value of devices that link the user's movements to the Avatar's, according to one example embodiment. According to one example embodiment, devices as simple as keystrokes or mouse moves may be used extremely effectively in the Navigational Interactivity that rules gaming today, according to one example embodiment. According to one example embodiment, the emergence of Communicational Interactivity may change the game, according to one example embodiment. According to one example embodiment, the recent attainment and increasing availability of Puppetry through MOCAP may be already yielding chat applications in which Avatars fill in for users, according to one example embodiment. According to one example embodiment, capturing user gestures, expressions, and other behaviors may be well within the grasp of current software and devices (see Perfect Puppetry), according to one example embodiment. According to one example embodiment, higher end mobile devices may now include 3D sensing hardware technologies such as lidar and ToF, that further enable puppetry, according to one example embodiment. The current disclosure, according to one example embodiment, may enable a comprehensive method to dynamically revise these captured movements to generate personality and shifting mood in the Avatar. The current disclosure may also enable the generation of Impulsive Behavior such that the Avatar diverts from the user's control for emotional reasons, according to one example embodiment. This, in turn, may enable the current disclosure's gamification, wherein a user's ability to steer their Avatar toward a dramatic goal may be challenged by control limits imposed by the Avatar's apparent emotional state, according to one example embodiment.

After sensing device captures raw data (such as video) on the user, this may be translated to animation data according to one example embodiment, in (FIG. 6, 615), according to one example embodiment. According to one example embodiment, such animation data may include positions and rotations of graphical “bones”, which may be applied to an Avatar's graphical ‘skeleton’ to make it mimic the human controller's movements, according to one example embodiment. As previously described here and in U.S. Pat. No. 10,207,405, the contents of which is incorporated herein by reference in its entirety, once the parameters from the AE (FIG. 6, 617) may be entered into the PTB equations (FIG. 6, 617), these MOCAP movements may be mathematically modified to express the Avatar's current mood, according to one example embodiment. According to one example embodiment, this last step may already introduce a level of Gamification by making the Avatar's movements different from the user's in normal conditions, according to one example embodiment. According to one example embodiment, the more impactful Gamification occurs when Impulsive Behaviors occur based in part on the Avatar's movements, according to one example embodiment.

According to one example embodiment, stored Animations may be brought into this mixture as well, according to one example embodiment. According to one example embodiment, in (FIG. 6, 616), in this case they will be selected triggered in the manner already covered in FIG. 1, after which the selected animation may be sent to the PTB and modified by the AE parameters in the PTB equations in the same manner as were the MOCAP animations, according to one example embodiment. According to one example embodiment, again, Impulsive Behaviors may occur based in part on the Avatar's movements, as previously described, according to one example embodiment.

According to one example embodiment, an added element of AE control may be provided here because now the AE may act as a ‘mixer’ selecting which animation input to emphasize, according to one example embodiment. According to one example embodiment, the means of selection here may be similar to the selection process described in FIG. 1, 10 & 11, according to one example embodiment.

According to one example embodiment, the overarching conclusion here may be that the enabling of Impulsive Behaviors, and Emergent Behaviors which in turn enable the Gamification of Drama may be preserved when Mixed Control methods may be also enabled, according to one example embodiment.

According to one example embodiment, this may be also true when the Avatar speaks with the user's voice instead of an Artificial Voice.

The Natural Voice Option

According to one example embodiment, to this point all discussions have treated Avatars speaking with an Artificial Voice, according to one example embodiment. According to one example embodiment, Natural Voice can also be used with the methods presented in this disclosure, as will be discussed here, according to one example embodiment.

FIG. 7: according to one example embodiment, may include an AE Avatar Speaking with its Players Voice, according to one example embodiment.

According to one example embodiment, in (FIG. 7, 701) as before, the user speaks to their client device, which may be a smartphone, tablet, laptop, VR headset, or other computer device, according to one example embodiment.

According to one example embodiment, in (FIG. 7, 702) the device's microphone records that user's voice, and that recorded sound may be sent in two directions: to the BTP where behavioral parameters may be extracted, as described in earlier examples, and to a Digital Effects Processor, according to one example embodiment, in (FIG. 7, 4), which step may be unique to this Natural Voice method, according to one example embodiment.

According to one example embodiment, in (FIG. 7, 707) the Avatar's AE calculates the parameters determining the Avatar's personality and mood as described in other methods previously presented. According to one example embodiment, in extraction of emotive parameters from analysis of the voice's sound may be the only example option presented in this figure, but options presented elsewhere may work as well, according to one example embodiment.

According to one example embodiment, in (FIG. 7, 708) the AE sends sound-effective emotive parameters to the Digital Effects Processor (FIG. 7, 704), according to one example embodiment. Such sound-effective emotive parameters may include elements that set pitch and rate in response to emotional parameters, according to one example embodiment. A simple example would be, low pitch, slow rate for sad; and, low pitch, fast rate for mad. The Digital Effects Processor then may transpose elements of that sound accordingly, to affect the emotive impact of the voice, according to one example embodiment.

In this natural voice process, the lipsync data produced by the TTS may be lost, so lipsync must be generated by other means, according to one example embodiment.

Two alternative lip sync methods follows:

According to one example embodiment, in (FIG. 7, 706) the sound may be analyzed by the BTP to determine probable lip position parameters, which may be then passed to the PTB, where they (along with any other animation sources) may be modified to exhibit the current Automated Emotional state of the Avatar, according to one example embodiment.

According to one example embodiment, in (FIG. 7, 711) this revised animation may be streamed to the Avatar's display mechanism, where it may be played concurrently with the sound of the user's voice, to make the Avatar appear to be speaking with this modified voice, according to one example embodiment.

According to one example embodiment, as an alternative to the above extraction of lip sync position from voice sound, the following method may be used, according to one example embodiment.

According to one example embodiment, in (FIG. 7, 713) MOCAP software (including face detection) may determine the user's lip position as they speak, according to one example embodiment.

According to one example embodiment, in (FIG. 7, 714 & 710) as with the preceding lip sync method, this lip animation data may pass to the PTB phase, where it (along with other animation sources) where it may be modified to exhibit the current Automated Emotional state of the Avatar, according to one example embodiment.

According to one example embodiment, in (FIG. 7, 711) this revised animation may be streamed to the Avatar's display mechanism, where it may be played concurrently with the sound of the user's voice, to make the Avatar appear to be speaking with this modified voice, according to one example embodiment.

The Gamification of Drama—

According to one example embodiment, when the focus of Avatar interactivity shifts from Navigation to Communication, Gamification may be impacted as well, according to one example embodiment. According to one example embodiment, challenges and Goals become emotional rather than spatia, according to one example embodiment. For example, the navigational challenge of overcoming an opposing character physically to gain territory may be replaced by the communication challenge of overcoming an opponent's hostile attitude to establish empathy, according to one example embodiment. According to one example embodiment, a navigation puzzle of making one's way through a maze, becomes a communication puzzle of reading reactions and navigating around psychological barriers. According to one example embodiment, this may become an interactive version of the Dramatic quality of movies, according to one example embodiment. According to one example embodiment, a vital component of this Gamification of Drama may be the synthesis of evolving relationships between Avatars, according to one example embodiment.

Parametric Coupling.—Synthesizing Emotional Relationships

FIG. 8 according to one example embodiment, may show two example AE Avatars functioning together in a single Virtual Space, according to one example embodiment.

According to one example embodiment, both Avatars shown here may be user-controlled, according to one example embodiment. However, the following methods could be equally applied to a user interacting with one or more AI-controlled NPCs, or two or more AI-controlled NPCs interacting with each other, due to the fact that the AE's emotivation of Avatar animation, and the Impulsive Behavior methods remain the same in both control cases, according to one example embodiment.

According to one example embodiment, in an example first step toward Gamification may be to enable the synthesis of an evolving emotional relationship between two or more Avatars, according to one example embodiment.

According to one example embodiment, in (FIG. 8, 805 & 806) as in the single-Avatar case, each Avatar may be influenced by its user's emotive and verbal input, according to one example embodiment.

According to one example embodiment, in (FIG. 8, 801 & 802) separate Avatars have separate Automated Emotions, and therefore each may express its own, unique personality or mood, regardless of who (or what AI) may be controlling it, according to one example embodiment.

Automated Personality—Mathematically Created ‘Vibe’

According to one example embodiment, parameters within each Avatar's Automated Emotions (AE) may control the output of dynamic mathematical oscillators within the PTB, which in turn control patterns of that Avatar's behavior, such as the rapidity of movements, flow of facial expressions, range of pitch and speed in the Avatar's voice, according to one example embodiment. According to one example embodiment, the settings of all these parameters may determine the apparent personality or mood of the Avatar's animated behavior, according to one example embodiment. According to one example embodiment, being coupled, these oscillators' output may create characteristic vibrations, which—although complex and non-deterministic—maintain a dynamic sufficient to be indicative of the intended mood, according to one example embodiment. For example, an oscillator-created nervous laugh may never repeat a particular pulse of laughter, but the taught attack and decay of each pulse of laughter may be sufficient to convey nervousness, according to one example embodiment.

According to one example embodiment, the same with a lazy head shake, according to one example embodiment:

According to one example embodiment, individual shakes may never be the same, but the dynamics of the oscillator create a recognizable similarity, according to one example embodiment. According to one example embodiment, added together in an overall Avatar performance, these tuned mathematical vibrations parallel the quality we informally refer to as the ‘vibe’ of a person, according to one example embodiment. According to one example embodiment, the insertion of this mathematically induced “vibe” into the Avatar's control mechanism may modulate any animated behavior, enabling that Avatar to maintain a constant apparent personality or mood, regardless of the source of the animation, according to one example embodiment.

According to one example embodiment, in (FIG. 8, 807) a lackadaisical AE Avatar will act lackadaisically, no matter who or what may be controlling it. A euphoric AE Avatar will maintain its euphoria, according to one example embodiment.

According to one example embodiment, in (FIG. 8, 811) an apparent emotional link can be established between Avatars by linking the AE parameters which define each Avatar's apparent personality or mood, according to one example embodiment.

Aligning ‘Vibes’—Mirroring:

According to one example embodiment, when the AE parameters of two Avatars become similar, they behaviorally ‘share a vibe’, and mirroring may be enabled, according to one example embodiment. According to one example embodiment, unlike matching animations in regular Avatars, which may produce identical behavior in both Avatars, matching parameter in AE Avatars will produce Avatars with behaviors which may be not identical, but share visual and audio characteristics that may be recognizable as ‘being in tune’ or ‘on the same wavelength,’ according to one example embodiment. According to one example embodiment, ‘Sharing a vibe’ or ‘being in tune’ may be not necessarily a positive thing, according to one example embodiment. For example, according to one example embodiment, two fiercely fighting dogs may be very much in tune, in terms of matched emotive parameters, according to one example embodiment. According to one example embodiment, in counter-mirroring may sometimes be a necessary method to negotiate one's way through a mathematically defined emotive maze, according to one example embodiment.

Synthesizing an Evolving Relationship:

According to one example embodiment, this coupling of parameters may enable a control mechanism for synthesizing apparent relationships between Avatars, according to one example embodiment. According to one example embodiment, in a simple example might be a control that drifts one Avatar's AE parameters toward another's in a time-dependent manner, so that the two Avatars' behavior becomes increasingly similar as they ‘get to know each other’, according to one example embodiment. According to one example embodiment, a more interactive example would be to make one Avatar's compound parameters approach those of another at a rate proportional to that Avatar's “trust” parameter, according to one example embodiment. According to one example embodiment, the example may enable the speed of parameter approach to be different for two Avatars, if one of them has more ‘trust’ than the other at that moment, according to one example embodiment. It also may enable interactivity, if users may increase their Avatar's ‘trust’ by, for example, avoiding Impulsive Behaviors, according to one example embodiment.

According to one example embodiment, as the name implies, parameter coupling may be achieved by mathematically coupling AE parameters in a manner similar to that used to mathematically couple animations. According to one example embodiment, this may enable swings in mirroring behavior to parallel swings in mood, according to one example embodiment.

Bringing in AI

According to one example embodiment, in PTB settings enable Avatars to perform “in character” (FIG. 8, 807), even when controlled by different users, according to one example embodiment. This Avatar ability to perform ‘in character’ extends to various AI controls, as well as to human users, according to one example embodiment.

According to one example embodiment, in also recall that an AI may assume Avatar control (FIG. 8, 808 & 809) to a degree ranging from subtle nuance during normal user control, to replacing user input entirely (such as to portray a user's conscience or a psychotic Avatar episode), according to one example embodiment. When this replacement by the AI may be total, the Avatar may be an NPC, according to one example embodiment. Thus, AE parameter-coupling may enable mirroring, counter-mirroring, and other sub-verbal behavioral linkages when the Avatar may be an NPC as well as when it's controlled by a human, according to one example embodiment.

Bringing it all Together

Uniting Communication and Navigation Interactivity

According to one example embodiment, in the plots of traditional media, such as books, plays and movies, generally include both character development and raw action to some degree, according to one example embodiment. Shakespeare mixed soliloquies with sword fights, according to one example embodiment. Even Rambo had his sensitive moments, according to one example embodiment.

Technical limitations in the new, raw game/metaverse medium have thus far skewed interactive plots strongly toward action, according to one example embodiment.

To address this issue, according to one example embodiment, the current disclosure's focus may be squarely on character development, according to one example embodiment. However, the wisdom of traditional media strongly suggests that mixing in some raw action will appeal to the human soul, according to one example embodiment. The following methods enable the combination of traditional Navigation Interactivity with this disclosure's Communication Interactivity, according to one example embodiment.

FIG. 9: According to one example embodiment, in combining Navigation Engine with Communication Engine, according to one example embodiment.

According to one example embodiment, in 912: a Navigation Engine may be added to the prior FIG. 8 (Emotive Parameter Coupling). This Navigation Engine may be a typical Game Engine, a software that manages Avatar interactions in the metaverse, or any other software that defines Avatar movement and body position within a typical Navigational game, according to one example embodiment.

According to one example embodiment, in 913 & 914 the Avatar movement and body position animations may be exported by the Navigation Engine during the progression of an interaction, according to one example embodiment. This Navigation Engine may handle collision detection and physical interactions between the Avatar and its environment, according to one example embodiment.

According to one example embodiment, in 803 & 804: The Navigation Engine's Avatar animations may be ‘emotivated’ in Avatar's PTB module so that the Avatar performs “in character” with its Automated Emotions, according to one example embodiment.

According to one example embodiment, in 915 & 916: These Avatar animations may also be sent to the appropriate Avatar's Behavior to Parameter (BTP) module for extraction of emotive parameters from physical interactions which may affect mood, according to one example embodiment. Information regarding more violent collisions may be included too, so that the full-body motion-modifiers of the AE may be turned off or minimized during these episodes, according to one example embodiment.

This method may enable the Communication and Navigation Engines to work in tandem to form a blended form of Gamification, according to one example embodiment. The interplay of emotional and material goals—the backbone of traditional drama—can now be enabled in interactive drama as well, according to one example embodiment.

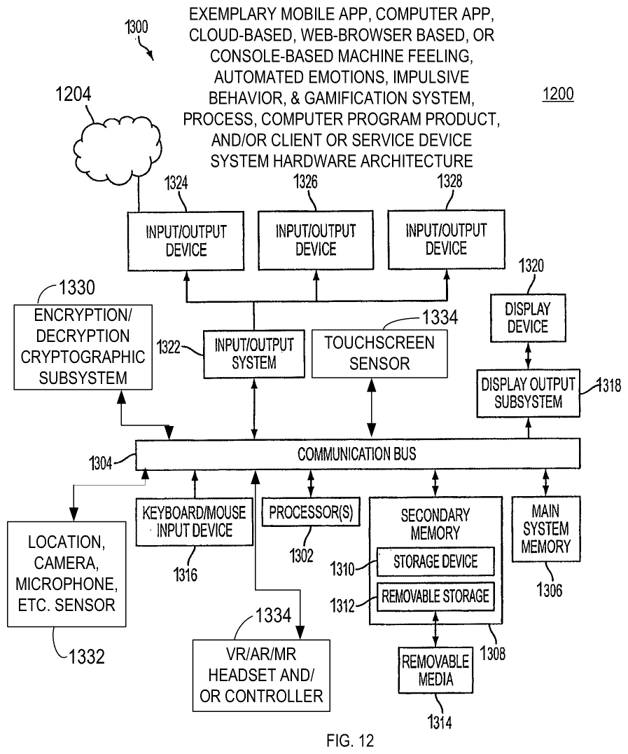

FIG. 12 depicting an example block diagram of an example user computing system as may be used as a hardware system architecture for one or more electronic computer devices including a client device, an electronic communications network device or a server device according to an example embodiment.

FIG. 12 depicts an exemplary embodiment of a schematic diagram 1200 illustrating an exemplary computing and communications system 1200 for providing an example mobile app, computer app, cloud-based, web-browser based, or console-based machine feeling, automated emotions, impulsive behavior, & gamification system, process, computer program product, and/or client or service device system hardware architecture, computing and/or communications device, and/or client, and/or server, and/or service provider device system hardware architecture, according to one exemplary embodiment, where the exemplary block diagram 1200 can include, e.g., an illustration of an exemplary computer system as can be used in an exemplary personal computer application, controller-based console, web-browser based application, augmented reality system, and/or virtual reality based system, mixed reality based system, holographic based system, each providing exemplary embodiments of an exemplary computer-implemented energy optimization energy storage device sizing and management system according to an exemplary embodiment of the present invention.

FIG. 12 depicts an exemplary embodiment of a block diagram 1200 illustrating an exemplary embodiment of a computer system 101 (not shown, but implied),102, 106 that may be used in conjunction with any of the systems depicted in diagram 100-1100 of FIGS. 1-11 or a hardware computing device, client/server/communication device, etc., or physical support layer below an example middleware, or software, or software application layer used to implement an example embodiment. Further, computer systems 102, 106 of block diagram 1200 may be used to execute any of various methods and/or processes such as, e.g., but not limited to, those discussed below with reference to FIGS. 1-11, as well as communication networks coupling various devices together, and executing any of various subsystems such as, e.g., but not limited to, devices implied to those skilled in the relevant art by 100, 200, 101, 102, 103, 104, 105, 106, 107, 108, 109, 110, 111, 112, 201, 202, 203, 204, 206, 206, 208, 209, 210, 212, 213, 214, 215, 216, STT, AI, TTS, BTP, AE, PTB, selector, stored animations storage subsystems and devices (not shown), devices 201, 202, 204, 207, 500, 517, 600 611, 612, 613, 615, 616, 617, AE 214, STT 203, 204, AI 205, 206, device shown displaying 510, 518, TTS 208, 209 microphone sensor device 201, 202, 700, camera, image, video, digital videoconferencing device, microphone, etc. and/or other sensor device 712, BTP 706, MOCAP 713, AE 707, PTB 710, DEP 704, 708, devices underlying 705, 711, 800, AE 808, 809, AI 810, STT 812, 817, TTS 813, 818, STT 820, 816, TTS 815, 819, 900, 1000, 1100,1200, PTB 1017, AE 214, electronic communication network 1200, devices 1324, 1326, 1328, etc. FIG. 12 depicts an exemplary embodiment of a computer system 102, 106 that may be used in computing devices such as, e.g., but not limited to, client 106 and/or server 102 computing devices according to an exemplary embodiment of the present invention. FIG. 12 depicts an exemplary embodiment of a computer system that may be used as client device 106, or a server device 102, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 1200 is shown in FIG. 12, depicting an exemplary embodiment of a block diagram of an exemplary computer system useful for implementing the present invention. Specifically, FIG. 12 illustrates an example computer 1200, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® 10/7/95/NT/98/2000/XP/CE/, etc. available from MICROSOFT® Corporation of Redmond, Wash., U.S.A., SOLARIS® from SUN® Microsystems, now Oracle Corporation, previously of Santa Clara, Calif., U.S.A., OS/2 from IBM® Corporation of Armonk, N.Y., U.S.A., Mac/OS, OSX, iOS from APPLE® Corporation of Cupertino, Calif., U.S.A., etc., ANDROID available from GOOGLE, a division of ALPHABET CORPORATION of Palo Alto, CA, USA, or any of various versions of UNIX® (a trademark of the Open Group of San Francisco, Calif, USA) including, e.g., LINUX®, UBUNTU, BSD UNIX, DEBIAN, HPUX®, IBM AIX®, Sun Solaris, GNU/Linux, MacOS X, Debian, Minix, V7 Unix, FreeBSD, Kernel, Android, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 1300 is shown in FIG. 13. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, augmented reality devices (AR), virtual reality (VR) devices, mixed reality (MR) devices, OCULUS RIFT based, META based, metaverse systems, mobile telephone based systems, smartphone based, mobile phone based, digital communications system, television, teleconferencing, devices, mobile communication devices, augmented vision systems, augmented holographic systems, electronic communication systems, wired communication systems, wireless communication systems, routers, gateways, communication switches, transmitters, receivers, transceivers, satellite communication systems, WIFI, WIMAX, VSAT, SATCOM, etc., may also be implemented using a computer such as that shown in FIG. 12.

The computer system 1300 may include one or more processors, such as, e.g., but not limited to, processor(s) 1302. The processor(s) 1302 may include, a microprocessor, nanoprocessor, quantum computer, any of various conventional digital architecture processors including, e.g., but not limited to, Pentium, CORE i7, i5, i3, i9, etc., ARM, CISC, RISC, POWER, multi-processor, and/or multi-core, quadcore, etc., field programmable gate array (FPGA), application specific integrated circuit (ASIC), cryptographic processor, cryptographic subsystem, a system on a chip (SOC), etc., may be coupled or connected to a communication infrastructure 1304 (e.g., but not limited to, a communications bus, a backplane, a mother board, a cross-over bar, or network, etc.). Various exemplary software embodiments may be described in terms of this exemplary computer system. After reading this description, it will become apparent to a person skilled in the relevant art(s) how to implement the invention using other computer systems and/or architectures. In an exemplary embodiment, a cryptographic controller 1330 can be included, in an exemplary embodiment, and can be used to, e.g., but not limited to, authenticate a user device, and/or provide encryption and/or decryption processing, according to an exemplary embodiment.

Computer system 1300 may include a display interface 1318 that may forward, e.g., but not limited to, graphics, text, and other data, etc., from the communication infrastructure 1304 (or from a frame buffer, etc., not shown) for display on the display unit 1320.

The computer system 1200 may also include, e.g., but may not be limited to, a main memory 1306, which may include, e.g., but not limited to, random access memory (RAM), volatile and nonvolatile, synchronous digital (SDRAM), flash memory, and/or a secondary memory 1308, etc. The secondary memory 1308 may include, for example, (but not limited to) a storage device 1310 such as, e.g., but not limited to, a hard disk drive and/or a removable storage drive 1312, representing, e.g., but not limited to, a floppy diskette drive, a magnetic tape drive, an optical disk drive, a compact disk (CD-ROM) device, write once read many (WORM), Read Write (RW), Read (R), a magneto-optical (MO) drive, a digital versatile disk (DVD) device, BLU-RAY, and/or other Digital Storage Disk, electronic, magnetic, optical, magneto-optical, and/or optical storage device, etc. The removable storage drive 1312 may, e.g., but not limited to, access, read from and/or write to a removable storage unit 1314 in a well known manner. Removable storage media unit 1314, may also be called a program storage device or a computer program product, and may represent, e.g., but not limited to, a floppy disk, magnetic tape, optical disk, CD-ROM disk, a MO media, a DVD disk, FLASH MEMORY, USB stick, SDRAM, memory device, etc. which may be accessed, read from, and/or written to by removable storage drive 1312. As will be appreciated, the removable storage unit 1314 may include, e.g., but not limited to, a computer usable storage medium having stored therein computer software and/or data.

In alternative exemplary embodiments, secondary memory 1308 may include other similar devices for allowing computer programs or other instructions to be loaded into computer system 1200. Such devices may include, for example, a removable storage unit 1314 and a storage subsystem interface adapter (not shown.) Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM), SDRAM, FLASH, and/or associated socket, and/or storage and/or processing and/or memory, and/or integrated devices, and/or other removable storage units 1314 and interfaces, which may allow software and data to be transferred from the removable storage unit 1314 to computer system 1200.

Computer 1200 may also include, e.g., but not limited to, an input device 1316 such as, e.g., (but not limited to) a mouse or other pointing device such as a digitizer, and/or a keyboard or other data entry device (not separately labeled).

Computer 1200, 1300 may also include, e.g., but not limited to, output devices 1320, such as, e.g., (but not limited to) display, touchscreen, touch sensor, proximity sensory, printers, and output subsystem display interface 1318, etc. exemplary output devices such as, e.g., but not limited to, graphic interface to graphics controller, graphics memory and/or graphics I/O, and/or video output, audio output, HDMI, max, mini, etc., display connector, VGA, XGA, SVGA, UHD, 4K, 8K, 16K, 32K, 64K, etc., and/or a storage interface, cable, wired, wireless, etc. and/or a storage interface, cable, wired, wireless, a bus, exemplary memory SDRAM and memory controller SDRAM controller, and exemplary MPEG decoder, according to an exemplary embodiment. According to an exemplary embodiment, the exemplary graphic interface can be coupled to one or more I/O controllers for coupling to exemplary interactive elements such as, e.g., but not limited to, a controller input interface such as, e.g., but not limited to, a mouse, keyboard, joystick, stylus, console controller, a Playstation, Xbox, Nintendo Wii, or Switch controllers, and the like, etc., external data and/or plugin capable interfaces such as, e.g., but not limited to, a PCMCIA I, II, III, IV, V, etc. interface, removable or accessible storage devices such as, e.g., but not limited to, a CD-ROM, DVD-ROM/RW, BLURAY, UHD BLURAY, electronic, magnetic, optical, magneto-optical, FLASH SDRAM, DRAM, USB devices, memory card, ETC., memory and/or other storage media, etc., output devices such as, e.g. but not limited to, printer(s), display, display subsystems, sound card interface and/or speakers, headphones, SONOS, wireless audio, BLUETOOTH, WIFI Audio, and/or audio output systems, optical audio, etc., network interface cards (NICs) such as, e.g., but not limited to, Ethernet MAC, Token Ring, Fibre channel, optical fibre network interface, 10/100/ and/or 1000, network interfaces, etc., physical interfaces including twisted pair, shielded twisted pair, CableTV, CATV, optical fibre, enhanced shielded ethernet cabling, IBM cabling system, optical fibre multiplexing, routers and/or switches, firewalls, security equipment, cable modems, WIFI modems, WIMAX modems, etc., various ports, parallel, serial, fibre, serial bus, universal serial bus (USB), A, B, C, 1.0, 2.0, 3.0, etc., advanced power management, battery and/or AC power supply, and/or voltage regulation and external alternative power AC, DC, etc., and/or or networking infrastructure, etc.

Computer 1200, 1300 may also include, e.g., but not limited to, input/output (I/O) system 1322 such as, e.g., (but not limited to) a communications interface, a cable and communications path, (not separately shown) etc., as well as I/O devices 1324, 1326, 1328, for example. These devices 1324, 1326, 1328, may include, e.g., but not limited to, a network interface card, and modems (not separately labeled). The communications interface may allow software and data to be, e.g., transferred between computer system 1300 and external devices over a network 104, as shown. Examples of the communications interface may include, e.g., but may not be limited to, a modem, a network interface (such as, e.g., an Ethernet card), a communications port, a Personal Computer Memory Card International Association (PCMCIA) or PC-Card slot and card, etc. Software and data transferred via communications interface may be in the form of signals 1330 (not shown) which may be electronic, electromagnetic, optical or other signals capable of being received by communications interface. These signals 1330 may be provided to communications interface via, e.g., but not limited to, a communications path (e.g., but not limited to, a channel). This channel may carry signals, which may include, e.g., but not limited to, propagated signals, and may be implemented using, e.g., but not limited to, wire or cable, fiber optics, a telephone line, a cellular link, an radio frequency (RF) link and other communications channels, etc. an exemplary system network hardware architecture, according to an exemplary embodiment. FIG. 9 depicts an exemplary embodiment of a block diagram 900 of an exemplary network hardware architecture, including various exemplary communications network technologies in an exemplary schematic block diagram illustrating exemplary controller systems as can be used in the onsite controller, and/or for coupling to exemplary cloud-based application server(s), and/or database(s), as can be executed on exemplary laptop and/or notebook, desktop, and/or server, computing devices and/or PC and/or mobile devices, wired, and/or wirelessly coupled to an exemplary but nonlimiting WIFI router or the like to an exemplary router for access to other router(s) and/or host(s) on the Internet, and/or servers, and/or clients, and/or peer based devices, and/or Internet of Things (IOT) based appliances, and the like, and/or network switch(es) and/or VoIP devices, and/or IP phones, and/or telephony devices, and/or desktop PCs, server PCs, handheld, laptop, notebook and/or mobile devices, and/or peripheral devices such as, e.g., but not limited to, scanner(s), camera(s), touchscreen(s), other sensors, input devices, mouse, stylus, keypad, keyboard, microphone, output devices, printers, televisions, smartv, monitors, flatscreen, touch-enabled, LCD, LED, OLED, UHD LED, QLED, etc., gateways, gateway switches between alternative network topologies, e.g., ring-based topologies, bus topology, CSMA/CD, packet based, token ring, fibre channel, Microwave, IR, RF, 3G, 4G, 5G, 6G, nG, etc., according to various exemplary embodiments.

The computer 1200 may be coupled to other, or multiple devices coupled via communications network 1204 to other devices (not shown) as part of system 1300 including, e.g., but not limited to, clients, servers, routers, cloud-based computers, and other client devices, server devices, load-balancing, web servers, application servers, web devices, browser-based devices, smart clients, thin clients, fat clients, servers, network accessible storage, databases, mobile devices, transportable devices, desktop, laptop, notebook, tower, integrated monitor, etc. devices, etc.

In this document, the terms “computer program medium” and “computer readable medium” may be used to generally refer to media such as, e.g., but not limited to removable storage drive 1314, a hard disk installed in storage device 1310, and signals 1330, etc. The signals at times are stored in a nonvolatile manner on electronic memory storage devices. These computer program products may provide software to computer system 1200, 1300. The invention may be directed to such computer program products, which may be executable on one or more electronic computer processors, microprocessors, and/or cores and/or multi-processor cores, microcontrollers, etc.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose ‘device’ selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others, when in a nonvolatile form.

Computer programs (also called computer control logic), may include object oriented computer programs, and may be stored in main memory 1306 and/or the secondary memory 1308 and/or removable storage media units 1314, also called computer program products. Such computer programs, when executed, may enable the computer system 1300 to perform the features of the present invention as discussed herein. In particular, the computer programs, when executed, may enable the processor 1302 to provide a method to resolve conflicts during data synchronization according to an exemplary embodiment of the present invention. Accordingly, such computer programs may represent controllers of the computer system 1300.

In another exemplary embodiment, the invention may be directed to a computer program product comprising a computer readable medium having control logic (computer software) stored therein. The control logic, when executed by the processor 1302, may cause the processor 1302 to perform the functions of the invention as described herein. In another exemplary embodiment where the invention may be implemented using software, the software may be stored in a computer program product and loaded into computer system 1300 using, e.g., but not limited to, removable storage drive 1312, storage device 1310 or communications interface, etc. The control logic (software), when executed by the processor 1302, may cause the processor 1302 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium May include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The exemplary embodiment of the present invention makes reference to wired, or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G, 4G, 5G, 6G, 7G, nG wireless, BLUETOOTH, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB), etc.

BLUETOOTH is an emerging wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11 a, b, d and g, (including, e.g., but not limited to IEEE 802.11g-2003, etc.), 802.16, Wi-Max, etc.

An exemplary computer-implemented energy optimization energy storage device sizing and management system service provider system can include computer-implemented method of electronically sizing, electronically managing, and electronically hosting exemplary computer-implemented energy optimization energy storage device sizing and management systems and of providing in one exemplary embodiment, and access to devices, via, e.g., an exemplary communications network to a plurality of electronic computing devices configured as set forth in the claims, and can include various inputs and/or outputs including any of various sensors including, e.g., but not limited to, touch screens, kiosks, instrument panels, tablet, Phablet, smart phone, a mobile device, smart television, LED screen, LCD screen, LED, LCD, touch sensors, pressure sensors, accelerometers, location sensors, energy based sensors, zygbee devices, intelligent devices, Internet of Things (iOT) devices, etc., data database collection sensor/gatherers, system service provider datasets, data sensors, utility pricing data, blockchain components, encrypted cryptographically protected user information and account user passwords, and/or other private data, distributed ledgers, etc. Specifically, FIG. 13 illustrates an example computer-implemented energy optimization energy storage device sizing and management system system service provider computer 1300, which in an exemplary embodiment may be, e.g., (but not limited to) a exemplary computer-implemented energy optimization energy storage device sizing and management system service provider personal computer (PC) system in one exemplary embodiment, running an operating system such as, e.g., (but not limited to) MICROSOFT® WINDOWS® 10/8.1/8/7/NT/98/2000/XP/CE/ME/VISTA/Windows 10, etc. available from MICROSOFT® Corporation of Redmond, Wash., U.S.A. However, the invention may not be limited to these platforms. Instead, the invention may be implemented on any appropriate exemplary computer-implemented energy optimization energy storage device sizing and management system service provider computer system running any appropriate operating system such as, e.g., but not limited to, Mac OSX, a Mach system, Linux, Ubuntu, Debian UNIX, iOS, OSX+ any variant Debian, Ubuntu, Linux, Android (available from Alphabet, and/or Google), etc., and/or another programming environment such as, e.g., but not limited to, Java, C, C++, C#, Python, Javascript, Ruby on Rails, PHP, LAMP, NDK, HTML, HTML5, XML, ADOBE FLASH, or the like. In one exemplary embodiment, the present invention may be implemented on an exemplary computer-implemented energy optimization energy storage device sizing and management system service provider computer system, including a computer processor, and memory, with instructions stored in the memory configured to be executed on the computer processor, operating as discussed herein. An exemplary computer-implemented energy optimization energy storage device sizing and management system service provider computer system, exemplary computer-implemented energy optimization energy storage device sizing and management system service provider computer 1300 may be shown in FIG. 13. Other components of the invention, such as, e.g., (but not limited to) exemplary computer-implemented energy optimization energy storage device sizing and management system service provider computing device, a communications device, mobile phone, a telephony device, a telephone, a personal digital assistant (PDA), a personal computer (PC), a handheld PC, an interactive television (iTV), a digital video recorder (DVD), a tablet computer, an iPad, an iPhone, an Android phone, a Phablet, a mobile device, a smartphone, a wearable device, a network appliance, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 13. Services may be provided on demand using, e.g., but not limited to, an interactive television (iTV), a video on demand system (VOD), and via a digital video recorder (DVR), or other on demand viewing system.

The exemplary computer-implemented energy optimization energy storage device sizing and management system service provider computer system 1300 may include one or more processors, such as, e.g., but not limited to, processor(s) 1304 such as, e.g., but not limited to, a CORE i7, or the like, Pentium, QuadCore, Multiprocessor, SOC, Microcontroller, Programmable Logic Controller (PLC), microprocessor, nanoprocessor, quantum computer, etc. The exemplary computer-implemented energy optimization energy storage device sizing and management system service provider processor(s) 1304 may be connected and/or coupled to a communication infrastructure 1306 (such as, e.g., but not limited to, a communications bus, cross-over bar, or network, etc.). Various exemplary software embodiments may be described in terms of this exemplary computer-implemented energy optimization energy storage device sizing and management system service provider computer system. After reading this description, it may become apparent to a person skilled in the relevant art(s) how to implement the invention using other exemplary computer-implemented energy optimization energy storage device sizing and management system service provider computer systems and/or architectures. According to an exemplary embodiment, the system can include an exemplary computer-implemented energy optimization energy storage device sizing and management system service provider and data transformer 1334. In an exemplary embodiment, a cryptographic controller 1330 can be included, in an exemplary embodiment, and can be used to, e.g., but not limited to, authenticate a user device, and/or provide encryption and/or decryption processing, according to an exemplary embodiment.

Exemplary computer-implemented energy optimization energy storage device sizing and management system service provider computer system 1300 may include a display interface 1302 that may forward, e.g., but not limited to, graphics, text, and other data, etc., from the communication infrastructure 1306 (or from a frame buffer, etc., not shown) for display on the display unit 1320, or other output device 1318, 1334, 1320, 1334 (such as, e.g., but not limited to, a touchscreen, etc.).

The exemplary computer-implemented energy optimization energy storage device sizing and management system service provider computer system 1300 may also include, e.g., but may not be limited to, a main memory 1306, random access memory (RAM), and a secondary memory 1308, etc. The secondary memory 1308 may include, for example, (but not limited to) a hard disk drive 1310 and/or a removable storage drive 1312, representing a floppy diskette drive, a magnetic tape drive, an optical disk drive, a compact disk drive CD-ROM, etc. The removable storage drive 1312 may, e.g., but not limited to, read from and/or write to a removable storage unit 1312 in a well known manner. Removable storage unit 1312, 1314, also called a program storage device or a computer program product, may represent, e.g., but not limited to, a floppy disk, magnetic tape, solid state disc (SSD), SDRAM, Flash, a thumb device, a USB device, optical disk, compact disk, etc. which may be read from and written to by removable storage drive or media 1314. As may be appreciated, the removable storage unit 1312, 1314 may include a computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CD¬ROM) or a digital versatile disk (DVD); a magnetic tape; and/or a memory chip, etc. Communications networking subsystem can be coupled to an electronic network coupled to a data provider, various secure connections allowing electronic receipt of data, and transfer of data to partner systems.

In alternative exemplary embodiments, secondary memory 1308 may include other similar devices for allowing computer programs or other instructions to be loaded into computer system 1300. Such devices may include, for example, a removable storage unit 1314 and an interface 1320. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 1322 such as, e.g., but not limited to, SDRAM, Flash, a thumb device, a USB device, and interfaces 1320, which may allow software and data to be transferred from the removable storage unit 1322 to computer system 1300.

Exemplary computer-implemented energy optimization energy storage device sizing and management system service provider computer 1300 may also include an input device 1316, 1334 such as, e.g., (but not limited to) a mouse or other pointing device such as a digitizer, and a keyboard or other data entry device (not shown), or an input sensor device 1332, location sensor and/or other sensor 1332, such as, e.g., but not limited to, a touch screen, a pressure sensor, an accelerometer, and/or other sensor device such as, e.g., a pressure sensor, a rangefinder, a compass, a camera, accelerometer, gyro, ultrasonic, biometric, secure authentication system, etc.

Exemplary computer-implemented energy optimization energy storage device sizing and management system service provider computer 1300 may also include output devices, such as, e.g., (but not limited to) display 1330, and display interface 1302, or other output device 1340, 1320, Augmented Reality, Virtual Reality device, mixed reality, holographic display, etc. 1334, touchscreen 1336. Exemplary computer-implemented energy optimization energy storage device sizing and management system service provider computer 1300 may include input/output (110) devices such as, e.g., (but not limited to) sensors, touch sensitive, pressure sensitive input systems, accelerometers, and/or communications interface 1324, cable 1328 and communications path 1326, etc. These communications networking devices may include, e.g., but not limited to, a network interface card, and modems (neither are labeled).

From a data model, which can automate the process of creating an exemplary computer-implemented energy optimization energy storage device sizing and management system service provider computer system 1354, can process incoming electronic data and can transform the data into exemplary computer-implemented energy optimization energy storage device sizing and management system pages, and/or related social media posts, and can then provide the transformed data, in the form of data indicative of the one or more exemplary computer-implemented example embodiment of an example mobile app, computer app, client and/or server based, and/or cloud-based, web-browser based, or console-based machine feeling, automated emotions, impulsive behavior, & gamification system, process, computer program product, and/or social media system, and/or communication system, and/or computer system, and/or client or service device system hardware architecture, storage device sizing and management system amounts, electronic database, and electronic funds process and disbursement information, and processing to initiate electronic disbursement, and can be provided to an electronic decision support system (DSS) 1358, and/or computer database management system (DBMS) 1360 (which can be a relational database, and/or can use a graph database, an SQL database, a noSQL database, and/or other social networking and/or graph database, and/or electronic interactive, graphical user interface (GUI) system 1362 (not shown). Each of the exemplary DSS 1358, DBMS 1360 and/or EIGUI system 1362, can then, using e.g., but not limited to, a cryptographic processor and/or a crypto chip controller, or the like, can then encrypt the data using electronic encryptor 1364, which can make use of one or more cryptographic algorithm electronic logic 1366, which can include encryption code, a cryptographic combiner, etc., and may be stored in encrypted form, according to an exemplary embodiment, in a computer database storage facility, from computer database storage device 1368, and from there the process can continue with use of the cryptographic algorithm electronic logic 1370, and electronic decryptor 1372, which can decrypt and/or provide a process for decrypting encrypted data, and/or by providing such data to the DSS 1358, the DBMS 1360, or the EIGUI 1362, if authorized (not shown). By using encryption/decryption, certain algorithms can be used, as described above, including, e.g., but not limited to, AES encryption, RSA, PKI, TLS, FTPS, SFTP, etc. and/or other cryptographic algorithms and/or protocols.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An exemplary computer-implemented energy optimization energy storage device sizing and management system service provider processing can include algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as, e.g., but not limited to, “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term exemplary computer-implemented energy optimization energy storage device sizing and management system service provider “system” or “processor” “system on a chip” “microcontroller” “multi-core” may refer to any device or portion of a device that processes electronic data from registers and/or memory to transform that electronic data into other electronic data that may be stored in registers and/or memory. An exemplary computer-implemented energy optimization energy storage device sizing and management system service provider “computing platform” may comprise one or more processors.

Embodiments of the present invention may include exemplary computer-implemented example embodiment of an example mobile app, computer app, client and/or server based, and/or cloud-based, web-browser based, or console-based machine feeling, automated emotions, impulsive behavior, & gamification system, process, computer program product and management system service provider apparatuses for performing the operations herein. An apparatus may be specially constructed for the desired purposes, selectively activated or reconfigured by an exemplary computer-implemented energy optimization energy storage device sizing and management system service provider program stored in the device in coordination with one or more special purpose data sensors.

In yet another exemplary embodiment, the invention may be implemented using a combination of any of, e.g., but not limited to, hardware, firmware and software, etc.

In one or more embodiments, the present embodiments are embodied in machine-executable instructions. The instructions can be used to cause exemplary computer-implemented energy optimization energy storage device sizing and management system service provider processing device, for example a special-purpose exemplary computer-implemented example embodiment of an example mobile app, computer app, client and/or server based, and/or cloud-based, web-browser based, or console-based machine feeling, automated emotions, impulsive behavior, & gamification system, process, computer program product and management system service provider processor, which is programmed with the exemplary computer-implemented example embodiment of an example mobile app, computer app, client and/or server based, and/or cloud-based, web-browser based, or console-based machine feeling, automated emotions, impulsive behavior, & gamification system, process, computer program product and management system service provider instructions, to perform the steps of the present invention. Alternatively, the steps of the present invention can be performed by specific exemplary computer-implemented example embodiment of an example mobile app, computer app, client and/or server based, and/or cloud-based, web-browser based, or console-based machine feeling, automated emotions, impulsive behavior, & gamification system, process, computer program product and management system service provider hardware components that contain hardwired logic for performing the steps, or by any combination of programmed computer components and custom hardware components. For example, the present invention can be provided as exemplary computer-implemented example embodiment of an example mobile app, computer app, client and/or server based, and/or cloud-based, web-browser based, or console-based machine feeling, automated emotions, impulsive behavior, & gamification system, process, computer program product and management system service provider computer program product, as outlined above. In this environment, the embodiments can include a machine-readable medium having exemplary computer-implemented example embodiment of an example mobile app, computer app, client and/or server based, and/or cloud-based, web-browser based, or console-based machine feeling, automated emotions, impulsive behavior, & gamification system, process, computer program product and management system service provider instructions stored on it. The exemplary computer-implemented example embodiment of an example mobile app, computer app, client and/or server based, and/or cloud-based, web-browser based, or console-based machine feeling, automated emotions, impulsive behavior, & gamification system, process, computer program product and management system service provider can be used to program any processor or processors (or other electronic devices) to perform a process or method according to the present exemplary embodiments. In addition, the present invention can also be downloaded and stored on a computer program product. Here, the program can be transferred from a remote computer (e.g., a server) to a requesting computer (e.g., a client) by way of data signals embodied in a carrier wave or other propagation medium via a communication link (e.g., a modem or network connection) and ultimately such signals may be stored on the computer systems for subsequent execution.

Exemplary wireless protocols and technologies used by a communications network may include BLUETOOTH, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), and packet switched core networks (PS-CN). Also included are various generation wireless technologies. An exemplary non-inclusive list of primarily wireline protocols and technologies used by a communications network includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

The embodiments may be employed across different generations of exemplary special purpose index construction wireless devices. This includes 1G-5G according to present paradigms. 1G refers to the first generation wide area wireless (WWAN) communications systems, dated in the 1970s and 1980s. These devices are analog, designed for voice transfer and circuit-switched, and include AMPS, NMT and TACS. 2G refers to second generation communications, dated in the 1990s, characterized as digital, capable of voice and data transfer, and include HSCSD, GSM, CDMA IS-95-A and D-AMPS (TDMA/IS-136). 2.5G refers to the generation of communications between 2G and 3 G. 3G refers to third generation communications systems recently coming into existence, characterized, for example, by data rates of 144 Kbps to over 2 Mbps (high speed), being packet-switched, and permitting multimedia content, including GPRS, 1.times.RTT, EDGE, HDR, W-CDMA. 4G refers to fourth generation and provides an end-to-end IP solution where voice, data and streamed multimedia can be served to users on an “anytime, anywhere” basis at higher data rates than previous generations, and will likely include a fully IP-based and integration of systems and network of networks achieved after convergence of wired and wireless networks, including computer, consumer electronics and communications, for providing 100 Mbit/s and 1 Gbit/s communications, with end-to-end quality of service and high security, including providing services anytime, anywhere, at affordable cost and one billing. 5G refers to fifth generation and provides a complete version to enable the true World Wide Wireless Web (WWWW), i.e., either Semantic Web or Web 3.0, for example. Advanced technologies may include intelligent antenna, radio frequency agileness and flexible modulation are required to optimize ad-hoc wireless networks.

Furthermore, the exemplary computer-implemented example embodiment of an example mobile app, computer app, client and/or server based, and/or cloud-based, web-browser based, or console-based machine feeling, automated emotions, impulsive behavior, & gamification system, process, computer program product and management system service provider processes and processors need not be located at the same physical locations. In other words, each processor can be executed at one or more geographically distant processor, over for example, a LAN or WAN connection. A great range of possibilities for practicing the exemplary special purpose index construction embodiments may be employed, using different networking hardware and software configurations from the ones above mentioned. Although described with reference to an application server and/or a web-based browser-enabled environment, such as, e.g., but not limited to, a JAVA environment, the application could also be implemented in a client server architecture, or as a mobile based app running on iOS or Android, or the like, and can interact with a server of exemplary computer-implemented energy optimization energy storage device sizing and management system service provider via communication network technology. Also, it is important to note that reference to an electronic network component, is not to require only electronic components, but could also integrate with other common networking equipment including, e.g, but not limited to, optical networking equipment, optical fiber, ATM, SONET, etc.

According to one exemplary embodiment, the exemplary computer-implemented example embodiment of an example mobile app, computer app, client and/or server based, and/or cloud-based, web-browser based, or console-based machine feeling, automated emotions, impulsive behavior, & gamification system, process, computer program product and management system service provider can be integrated with mobile devices which can run an exemplary an example graphical user interface (GUI) of an exemplary smartphone, and/or mobile phone, and/or computer application, and/or tablet application, and/or Phablet application, etc., application can transmit and/or receive data to and/or from an example mobile exemplary computer-implemented example embodiment of an example mobile app, computer app, client and/or server based, and/or cloud-based, web-browser based, or console-based machine feeling, automated emotions, impulsive behavior, & gamification system, process, computer program product and management system application device and/or server, in various embodiments. Various exemplary GUI elements can be provided, including icons and/or buttons, which can provide certain functionality relating to the exemplary computer-implemented example embodiment of an example mobile app, computer app, client and/or server based, and/or cloud-based, web-browser based, or console-based machine feeling, automated emotions, impulsive behavior, & gamification system, process, computer program product and management system, according to an exemplary embodiment. Various exemplary GUI elements can include exemplary scroll bars for scrolling through exemplary lists of exemplary computer-implemented example embodiment of an example mobile app, computer app, client and/or server based, and/or cloud-based, web-browser based, or console-based machine feeling, automated emotions, impulsive behavior, & gamification system, process, computer program product and management system features, and/or lists of particular GUI element options, according to an exemplary embodiment. Various exemplary embodiments of the system may include, e.g., but not limited to, enhanced interactive features such as, e.g., but not limited to, Web 2.0, social networking posts and/or friend authentication and sharing features, enhanced security offer and acceptance of authorized user(s), ability to interact with other users in social media posts, enhanced demographically and/or psychographically targeted advertisements and/or content, a graph database based scaleable back office system for managing a large scaleable database of users, and/or social media posts, social media profiles for each user, ability to provide ratings and/or emoji and/or other interaction between users, and/or rating of users, comment posting, sharing, and/or electronically enabled micro-fundraising, and/or donations and/or tracking of funds raised using real currency, and/or foreign currency equivalents, including, e.g., but not limited to, cryptocurrencies, real currencies, electronic ledgers, block-chain ledgers, foreign currencies, mobile currencies, VENMO, PAYPAL, WEPAY, etc., according to various exemplary embodiments.

According to various example embodiments, communication flows and data flows may advantageously be encrypted and decrypted using any of various cryptographic algorithms to protect the transmission(s) of data between example subsystems, and/or to enhance user experience by avoiding unauthorized access to communications flows and/or any of the data used, stored, and/or transmitted in the exemplary mobile app, computer app, cloud-based, web-browser based, or console-based machine feeling, automated emotions, impulsive behavior, & gamification system, process, computer program product, and/or client or service device system hardware architecture system, server, client device systems, mobile device system, and/or communication devices and/or systems communicating over communication networks with other devices and/or subsystems as set forth in the above example embodiments. Key exchange algorithms may be used to authenticate users and/or hardware devices, and subsystems may be used to protect the identity of various encryption/decryption keys.

Cryptographic Functions

Cryptographic systems, according to an exemplary embodiment, can provide one or more of the following four example services. It is important to distinguish between these, as some algorithms are more suited to particular tasks, but not to others. To protect patient data, personal data can be encrypted prior to storage and can be decrypted before accessing the data, according to an exemplary embodiment. When analyzing requirements and risks, one needs to decide which of the four functions should be used to protect the proprietary data, according to an exemplary embodiment.

Authentication

Using a cryptographic system, according to an exemplary embodiment, one can establish the identity of a remote user (or system). A typical example is the SSL certificate of a web server providing proof to the user device that user device is connected to the correct server, according to an exemplary embodiment.

The identity is not of the user, but of the cryptographic key of the user. Having a less secure key lowers the trust one can place on the identity, according to an exemplary embodiment.

Non-Repudiation

The concept of non-repudiation is particularly important for financial or e-commerce applications, according to an exemplary embodiment. Often, cryptographic tools are required to prove that a unique user has made a transaction request, according to an exemplary embodiment. It must not be possible for the user to refute his or her actions, according to an exemplary embodiment.

For example, a customer can request a transfer of money from her account to be paid to another account, according to an exemplary embodiment. Later, she claims never to have made the request and demands the money be refunded to the account. If one has non-repudiation through cryptography, one can prove—usually through digitally signing the transaction request, that the user authorized the transaction.

Confidentiality

More commonly, the biggest concern can be to keep information private, according to an exemplary embodiment. Cryptographic systems, according to an exemplary embodiment, have been developed to function in this capacity. Whether it be passwords sent during a log on process, or storing confidential proprietary financial data in a database, encryption can assure that only users who have access to the appropriate key can get access to the proprietary data.

Integrity

One can use cryptography, according to an exemplary embodiment, to provide a means to ensure data is not viewed or altered during storage or transmission. Cryptographic hashes for example, can safeguard data by providing a secure checksum, according to an exemplary embodiment.

Cryptographic Algorithms

Various types of cryptographic systems exist that have different strengths and weaknesses, according to an exemplary embodiment. Typically, the exemplary cryptographic systems can be divided into two classes; 1) those that are strong, but slow to run, and 2) those that are quick, but less secure. Most often a combination of the two approaches can be used, according to an exemplary embodiment (e.g.: secure socket layer (SSL)), whereby we establish the connection with a secure algorithm, and then if successful, encrypt the actual transmission with the weaker, but much faster algorithm.

Symmetric Cryptography

Symmetric Cryptography, according to an exemplary embodiment, is the most traditional form of cryptography. In a symmetric cryptosystem, the involved parties share a common secret (password, pass phrase, or key), according to an exemplary embodiment. Data can be encrypted and decrypted using the same key, according to an exemplary embodiment. These symmetric cryptography algorithms tend to be comparatively fast, but the algorithms cannot be used unless the involved parties have already exchanged keys, according to an exemplary embodiment. Any party possessing a specific key can create encrypted messages using that key as well as decrypt any messages encrypted with the key, according to an exemplary embodiment. In systems involving a number of users who each need to set up independent, secure communication channels, symmetric cryptosystems can have practical limitations due to the requirement to securely distribute and manage large numbers of keys, according to an exemplary embodiment.

Common examples of symmetric algorithms include, e.g., but not limited to, DES, 3DES and/or AES, etc. The 56-bit keys used in DES are short enough to be easily brute-forced by modern hardware and DES should no longer be used, according to an exemplary embodiment. Triple DES (or 3DES) uses the same algorithm, applied three times with different keys giving it an effective key length of 128 bits, according to an exemplary embodiment. Due to the problems using the DES algorithm, the United States National Institute of Standards and Technology (NIST) hosted a selection process for a new algorithm. The winning algorithm was Rijndael and the associated cryptosystem is now known as the Advanced Encryption Standard or AES, according to an exemplary embodiment. For most applications 3DES, according to an exemplary embodiment, is acceptably secure at the current time, but for most new applications it is advisable to use AES, according to an exemplary embodiment.

Asymmetric Cryptography (Also Called Public/Private Key Cryptography)

Asymmetric algorithms, according to an exemplary embodiment, use two keys, one to encrypt the data, and either key to decrypt. These inter-dependent keys are generated together, according to an exemplary embodiment. One key is labeled the Public key and is distributed freely, according to an exemplary embodiment. The other key is labeled the Private Key and must be kept hidden, according to an exemplary embodiment. Often referred to as Public/Private Key Cryptography, these cryptosystems can provide a number of different functions depending on how they are used, according to an exemplary embodiment.

The most common usage of asymmetric cryptography is to send messages with a guarantee of confidentiality, according to an exemplary embodiment. If User A wanted to send a message to User B, User A would get access to User B's publicly available Public Key, according to an exemplary embodiment. The message is then encrypted with this key and sent to User B, according to an exemplary embodiment. Because of the cryptosystem's property that messages encoded with the Public Key of User B can only be decrypted with User B's Private Key, only User B can read the message, according to an exemplary embodiment.

Another usage scenario is one where User A wants to send User B a message and wants User B to have a guarantee that the message was sent by User A, according to an exemplary embodiment. In order to accomplish this, User A can encrypt the message with their Private Key, according to an exemplary embodiment. The message can then only be decrypted using User A's Public Key, according to an exemplary embodiment. This can guarantee that User A created the message because User A is then the only entity who had access to the Private Key required to create a message that can be decrypted by User A's Public Key, according to an exemplary embodiment. This is essentially a digital signature guaranteeing that the message was created by User A, according to an exemplary embodiment.

A Certificate Authority (CA), whose public certificates are installed with browsers or otherwise commonly available, may also digitally sign public keys or certificates, according to an exemplary embodiment. One can authenticate remote systems or users via a mutual trust of an issuing CA, according to an exemplary embodiment. One can trust their ‘root’ certificates, according to an exemplary embodiment, which in turn authenticates the public certificate presented by the server.

PGP and SSL are prime examples of systems implementing asymmetric cryptography, using RSA and/or other algorithms, according to an exemplary embodiment.

Hashes

Hash functions, according to an exemplary embodiment, take some data of an arbitrary length (and possibly a key or password) and generate a fixed-length hash based on this input. Hash functions used in cryptography have the property that it can be easy to calculate the hash, but difficult or impossible to re-generate the original input if only the hash value is known, according to an exemplary embodiment. In addition, hash functions useful for cryptography have the property that it is difficult to craft an initial input such that the hash will match a specific desired value, according to an exemplary embodiment.

MD and SHA-1 are common hashing algorithms, according to an exemplary embodiment. These algorithms are considered weak and are likely to be replaced in due time after a process similar to the AES selection, according to an exemplary embodiment. New applications should consider using SHA-256 instead of these weaker algorithms, according to an exemplary embodiment.

Key Exchange Algorithms

There are also key exchange algorithms (such as Diffie-Hellman for SSL), according to an exemplary embodiment. These key exchange algorithms can allow use to safely exchange encryption keys with an unknown party, according to an exemplary embodiment.

Algorithm Selection

As modern cryptography relies on being computationally expensive to break, according to an exemplary embodiment, specific standards can be set for key sizes that can provide assurance that with today's technology and understanding, it will take too long to decrypt a message by attempting all possible keys, according to an exemplary embodiment.

Therefore, we need to ensure that both the algorithm and the key size are taken into account when selecting an algorithm, according to an exemplary embodiment.

### CONCLUSION

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A computer-implemented method of altering animated behavior of a character avatar or artificial character comprising:
a) electronically establishing, by at least one electronic computer processor, at least one electronic data indicative of at least one parametric mathematical model configured to alter at least one kinetic property of the animated behavior of the character avatar or artificial character, in a manner that creates apparent changes of at least one or more of:
mood, or
personality,
in the character avatar or artificial character being animated;
b) electronically inserting, by the at least one electronic computer processor, electronic data indicative of an animation representative of the at least one electronic data indicative of the at least one parametric mathematical model, wherein the electronic data indicative of the animation representative of the at least one electronic data indicative of the at least one parametric mathematical model is inserted between timing:
of electronically displaying of animated behaviors of the character avatar or artificial character controlling the character avatar or artificial character, and
of electronically displaying of animated behaviors of the character avatar or artificial character being controlled, wherein the parametric mathematical model adds electronic data indicative of apparent mood and/or personality to the animations of the character avatar or artificial character;
c) electronically storing, by the at least one electronic computer processor, a set of at least one electronic data parameters applicable to said parametric mathematical model for a particular character avatar or artificial character, wherein at least one animation of the particular character avatar or artificial character comprises displaying behavioral attributes portraying at least one personality, or mood of the particular avatar or artificial character; and
d) electronically altering, by the at least one electronic computer processor, the set of the at least one electronic data parameters relating to displaying varying emotional states in the character avatar or artificial character.

2. The method according to claim 1, wherein the character avatar or artificial character is electronically controllable by human users, and/or the character avatars or artificial character are animated autonomously.

3. The method of claim 1, further comprising:
e) electronically mathematically linking, by the at least one electronic computer processor, the emotive parameters of various avatars to link the behavior of these avatars in a manner that portrays an emotional dynamic between them.

4. The method according to claim 1, wherein the character avatars comprise at least one or more of:
wherein the character avatar or artificial character is controllable by at least one human user via at least one electronic user controller device, or
wherein the character avatar or artificial character is animated autonomously.

5. A method of altering a behavior of at least one avatar in at least one virtual environment, wherein each of the at least one avatar is controlled by at least one user device controller of at least one human user, comprising:
a) electronically establishing, by at least one electronic computer processor, a psychological animation system of generating apparent personality or mood characteristics in an animation of the at least one avatar;
b) electronically enabling, by the at least one electronic computer processor, the psychological animation system to at least one or more of electronically interrupt or electronically alter control of the animation coming from the at least one user device controller of the at least one human user of the at least one avatar in a manner comprising portraying in the at least one avatar, at least one or more of an apparent mood, a personality, or another psychological factor, as revealed in the animation.

6. The method according to claim 5, further comprising:
c) electronically providing, by the at least one electronic computer processor, a method of altering the psychological animation system to display varying emotional states in the at least one avatar.

7. The method according to claim 5, further comprising:
d) electronically enabling, by the at least one electronic computer processor, electronically triggering of electronic data indicative of impulsive behaviors by the at least one avatar, wherein the psychological animation system comprises assuming increased control over the at least one electronic user device controller, and an animation input for the at least one avatar to electronically display at least one impulsive behavior in a final animation.

8. The method according to claim 7, wherein said at least one impulsive behavior at least one of partially replaces or completely replaces an input of a human controller from the at least one electronic user device controller.

9. The method of claim 7, further comprising:
e) electronically enabling, by the at least one electronic computer processor, the user-control restrictions imposed by the impulsive behaviors as challenges impeding ability of the human controller to guide the avatar toward a specified goal in a game-type situation.

10. The method according to claim 5, further comprising:
c) electronically enabling, by the at least one electronic computer processor, the triggering of non-user spoken dialogue in the avatar, wherein non-user dialogue is stored or AI-generated, and is spoken by the at least one avatar, rather than dialogue input of the human controller.

11. The method according to claim 10, wherein said non-user dialogue comprises at least one or more of: is electronically added to, electronically partially replaces, or electronically completely replaces, the electronic input of the human controller.

12. A method of procedurally generating emersive emotive behavior in avatars or robots, comprising:
a) electronically establishing, by at least one electronic computer processor, electronic data indicative of a set of parametric mathematical models capable of electronically simulating kinetic properties of human physiological responses and actions in a manner that may be parametrically tuned to electronically simulate various physiological or psychological states;
b) electronically combining, by the at least one electronic computer processor, the separate parametric mathematical models in a coupled dynamical system which may represent an electronic linking of these various physiological factors into combined parameters; and
c) electronically enabling, by the at least one electronic computer processor, the coupled dynamical system to procedurally animate unscripted catastrophic emersive behaviors under fluctuations in the combined parameters.

13. The method according to claim 12, wherein the electronic data indicative of physiological responses and actions mathematically electronically modeled comprise at least one or more of:
large muscle movement,
fine muscle movement, or
fluctuations in vocal dynamics during speech.

14. The method according to claim 12, wherein said fluctuations comprise extreme fluctuations as measured by a pre-determined threshold of variability of fluctuation in the combined parameters.
